(19) United States
(12) Patent Application Publication
(10) Pub. No.: US 2008/0019528 A1
(43) Pub. Date: Jan. 24, 2008

(54) Multicast Key Issuing Scheme For Large An Dmedium Sized Scenarios An Dlow User-Side Demands

(75) Inventor: Jan Kneissler, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,088

(22) PCT Filed: May 17, 2005
(86) PCT No.: PCT/IB05/51598

§ 371 Date: Nov. 14, 2006

(30) Foreign Application Priority Data
May 19, 2004 (EP) 04102207.0

(51) Int. Cl. H04L 9/08

(52) U.S. Cl. 380/279

(57) ABSTRACT

The system according to the invention comprises at least one sender S with key providing means (24) for providing group keys GK and address keys (Xⱼ, Yⱼ, Zⱼ). A plurality of receivers r each have accessing means (42, 50) for accessing individual receiver address key sets and group keys. Group keys are identical for all receivers of the same group. Each receiver address key set is a subset of the base set of address keys. The receiver address key sets are pairwise different for all pairs of receivers of the same group. For each individual receiver, there is one or more exclusion key (X, Y, Z), which is not contained in that receivers set of address keys. The system comprises authorization storage means (30) storing authorization information about each receiver Encryption means (24) are used to generate out of the message mk a plurality of encrypted messages mk*. Each encrypted message mk* is encrypted with a combination of keys in such a way that it can only be decrypted using all keys out of the combination of keys. Each encrypted message mk* is aimed at one group of receivers, and the combination contains group keys of that group. To exclude non-authorized receivers, the combination further contains one or more exclusion keys of non-authorized receivers of the group.

The invention relates to a system for selective multicast of a message, a broadcasting system and method for selective multicast.

In a basic data transmission system, data is transmitted from a sender over a channel to a plurality of receivers. The physical channel used for data transmission is outside of the scope of the present invention, and can include any known form of data transmission method and any type of media. The issue addressed in the present disclosure is how to transfer data selectively to a plurality of receivers, and to exclude other receivers from receiving the data. This selectivity is achieved by an encryption scheme specifically adapted for this task.

Data transmission from a sender to a plurality of receivers is termed “multicast” or “point-to-multipoint” transmission. Selective multicast transmission is already applied in areas like pay-TV. But even internet communication as well as mobile communication may make use of selective multicast.

In a broadcasting system, the data sent over the channel is scrambled, and the necessary key information to descramble the data—here termed “multicast key”—is distributed among the receivers, so that the desired selectivity—only authorized receivers can and unauthorized receivers cannot decrypt the message—is achieved. Due to the encryption employed, these systems are well suited for broadcasting applications, where the channel and method of transmission do not limit the number of receivers.

This method alone, however, is not very flexible with regard to membership changes. If a previously authorized receiver leaves the multicast group, the previously used multicast key (shared secret) needs to be changed, so that further transmissions are no longer readable for the excluded receiver. A new multicast key needs to be transmitted safely and selectively only to the remaining authorized receivers. In some applications, like pay-TV including pay-per-view systems, membership may be highly dynamic. For theses applications the overhead associated with the necessary key changes must be kept small. Especially in multicast or broadcasting systems with a medium number of receivers (e.g. 100 to 100,000), and even more for multicast systems with a large number of receivers (e.g. above 10,000) the bandwidth demands are very important. Further, it is highly desirable to be able to use simple and inexpensive hardware at the receiver side, especially in large systems with a high number of receivers. Thus, other important parameters of a multicast system are memory consumption and computational effort on the receiver side.

An example of a system for selective data transmission which addresses the above problem is given in U.S. Pat. No. 6,049,878. The system includes a sender and a number of receivers. At each receiver, multiple keys are accessible. A multicast key (here termed TEK, traffic encryption key) is shared with the sender and all other receivers. Additionally, each receiver holds a plurality of key encryption keys (KEK). The logical structure of the system is that of a binary tree, with the sender being the root and the receivers being the leaves. Each leaf holds the keys arranged in the path from root to leaf.

In case of leave operations, i.e. a receiver is no longer authorized to receive data, every key in the path to the leaving sender is changed in a bottom-up fashion. The multicast key (TEK) is then changed to exclude the leaving receiver. Further traffic is scrambled using the new, changed TEK, which can no longer be read by the leaving receiver.

The system and method disclosed in U.S. Pat. No. 6,049,878 succeed to reduce the bandwidth required in case of leave operations. However, for every leave operation, still the re-keying of a complete path in the logical tree is necessary.

The RFC2627 issued by the Internet Engineering Task Force IETF, entitled “Key Management For Multicast: Issues And Architectures”, June 1999, discusses various architectures for multicast groups. The specific problem of bandwidth and storage requirements for dynamic multicast groups is discussed for applications such as teleconferencing and distributed gaming. A recommended architecture is a hierarchical tree, as proposed in U.S. Pat. No. 6,049,878. As an alternative architecture, a pairwise key exchange between sender and receivers is proposed, where a sender performs a public key exchange according to the Diffie-Hellman protocol with each receiver, allowing the establishment of individual encryption keys (KEKs) used for transmitting the multicast key in encrypted form. In a refinement of this basic architecture, a different set of keys, called complementary variables, is distributed among the receivers. In RFC2627 all receivers receive all complementary variables, except for their own. It is thus possible to exclude individual receivers from the multicast group by generating a new multicast key based on the previous multicast key and the complementary variable of the receiver to be excluded.

The object of the present invention to propose a system for selective multicast of a message, a broadcasting system and method for selective multicast of a message which are particularly well-suited for a medium or large number of receivers.

According to the invention, this object is solved by a multicast system according to claim 1, a broadcasting system according to claim 15 and method according to claim 16. Dependent claims relate to preferred embodiments of the invention.

The system according to the invention comprises at least one sender and a plurality of receivers. It should be noted that, although the following discussion of secure multicast will be limited to one-way communication from the sender to the receivers, this certainly does not exclude the possibility of a back channel, i.e. possible reversal of the roles of sender and receiver during later communication.

The system allows selective multicast by use of encryption. Associated with the sender, i.e. either located at the sender or being accessible by the sender are key storage means storing a base set of group keys and a base set of address keys. Further, each receiver has accessing means—i.e. means suited to allow the receiver to access keys, i.e. through storage or reception—for accessing the individual receivers set of keys. The receivers are members of a plurality of groups. The individual receiver's key set comprises on one hand a receiver address key set, and on the other hand one or more group keys. All receivers within the same group can access the same group keys, but have different receiver address key sets. Each receiver address key set is a subset of the base set of address keys accessible at the sender.

For each individual receiver, there exists one or more exclusion key. An exclusion key is a key out of the base set of address keys, which is not contained in the individual receiver's key set. Encryption of a message with an exclusion key excludes a corresponding receiver from receiving this message, hence the term.

Further comprised in the system are authorization storage means, which may store authorization information about authorized and/or non-authorized receivers. In the present context of selective multicast, authorized receivers are to receive a message, while non-authorized receivers should not receive this message.

Selective multicast is effected by using encryption means for generating out of the message to be sent a plurality of encrypted messages, and by sending these encrypted messages. The encrypted messages are each encrypted with a combination of keys. These keys are in an AND-relationship, i.e. the message can only be decrypted if all keys out of the combination are known. Examples of such encryption methods with multiple keys will be discussed further on.

Each of the encrypted messages is aimed at a target group of receivers. While there may be multiple messages for one group, it is preferred to have only one encrypted message for each group of receivers. To ensure that only members of the target group receive the message (or, more precisely, are able to decrypt it and receive the clear text), the applied combination of keys contains at least one, preferably all group keys of the target group.

To ensure, within each group, that only authorized receivers receive the clear text message, the combination applied contains exclusion keys of non-authorized receivers within the target group.

Thus, the system and method according to the invention allows selective multicast of a message to a large number of receivers within several groups. The encryption used ensures by careful choice of the key combinations of the different encrypted messages that only authorized receivers may receive the message. As will be shown in connection with the preferred embodiment, this is a very effective solution, which allows to minimize the bandwidth necessary for selective multicast, and leads to low receiver side requirements n terms of storage and computational demands.

In a broadcasting system according to the invention, the above system and method for selective multicast is used to selectively transmit a scrambling key. The scrambling key is used to scramble content messages, which may then be descrambled by those receivers able to access a scrambling key. In the present context, the term “scrambling” relates to any sort of encryption, and is preferably a block cipher. The term “scrambling” is used here instead of “encrypting” to distinguish the scrambling of content messages from the above described encryption of multicast messages.

It should be noted that the invention is applicable to a wide range of applications. The channel used for transmission from the sender to the receivers can be any type of transmission method and/or medium. Also, practically any encryption method which uses a key to encrypt data can be used. This specifically implies the use of both symmetric and asymmetric encryption methods. Symmetric encryption methods use the same key for encryption and decryption, while in asymmetric encryption methods, the “key” is actually a key pair, of which one key part (usually referred to as the “public” key) is used for encryption and the other part (“secret key”) is used for decryption. Both types of methods can be used in a system according to the invention. The system is also not limited to a specific number of receivers. Obviously, the advantages of the system become more apparent in a system with a higher number of receivers, e.g. more than 1000 or above.

According to a preferred embodiment of the invention, there is a plurality of receiver address key sets, belonging to receivers of different groups, which are identical. This limits the number of address base keys which need to be stored at the sender. Having receivers with identical receiver address key sets does not exclude selectivity, since the receivers belong to different groups. It is further preferred, that there are not only some identical receiver address key sets, but that all receivers of a plurality of groups, more preferred of the majority of groups, and most preferred even of all groups, have the same receiver address key set. While this on one hand greatly reduces the total number of cryptographic keys in the system, it also offers as a further advantage that it is possible to send a single encrypted message, which can be decrypted by one or more receivers out of a plurality of group. As discussed above, encryption With a combination of keys is effected in such a way that all out of the combination of keys are needed to decrypt a message. There are different possibilities for implementing an encryption, where the keys are thus connected in AND-fashion. One possible way would be to generate a cryptographic key out of the keys in a combination, i.e. by using a mathematical operation on the keys. For example, two keys, which may be represented as binary numbers, may be XORed to obtain a combined key. An encryption with the combined key will generally only be possible to reverse if both original keys are known.

However, it is preferred to implement encryption with multiple keys as recursive encryption. This recursive encryption, which in the present context will also be referred to as “key chaining”, involves encrypting data with a first key to obtain first encrypted data, and to encrypt the first encrypted data further using a second key to obtain second encrypted data, and so on. Obviously, the finally obtained result after recursive encryption with a number of keys can only be read after recursive decryption with the same keys (generally in reverse order, if the order is important). To read correspondingly recursively encrypted data, the complete combination of keys used in the recursive encryption process needs to be available to a receiver.

According to a further development of the invention, the system comprises address key generating means to generate the base of address keys. The system further comprises selective key transmission means for selectively transmitting the generated address keys to the receivers. The accessing means at the receivers then comprise receiving means to receive the transmitted address keys. This allows to use temporary address keys, which are used only for a limited number of messages. In fact, it is preferred that address keys are only used for transmission of a small number of messages, e.g. less than 10. The address keys may also be used to transmit only a single message. Frequent change of address keys minimizes the susceptibility to attack of the system by coalition of receivers, who exchange the individual address keys.

For selective submission of newly generated address keys, it is preferred to use a further set of cryptographic keys, which are comprised in a selection base key set. Corresponding receiver selection key sets which are sub-sets of the selections base key set, are preferably stored at each receiver. Selection keys of receivers of the same group are pairwise not contained in each other. It is, however, preferred that receiver selection key sets of receivers of different groups are identical. This is preferably the case for all receivers of a plurality of groups, or the majority of groups, and most preferably for all groups. Using the above described key distribution, it is possible to achieve selective key transmission by encrypting the receiver address keys to be transmitted by a combination of selection keys. Here, receivers with identical receiver selection key sets receive the same set of address keys. An important issue for a system and a method according to the invention is the chosen key issuing scheme, i.e. the distribution of group keys, address keys and/or selection keys among the receivers. As will be further described with reference to the preferred embodiments, there are two specific issuing schemes preferred, one for medium sized scenarios (number of receivers roughly from 100 to 100,000) and the other for large scenarios (number of receivers above 10,000, preferably above 100,000).

In a first preferred issuing scheme, which is well suited for medium sized scenarios, there is only one exclusion key for each receiver. The exclusion key is contained in the receiver address key set of all receivers in the same group, except for the “owner” of the exclusion key, i.e. the receiver that can be excluded by using this key. Thus, encryption of the message with the exclusion key of a specific receiver will make it possible for all receivers in the group to decrypt the message, except for the excluded receiver. Likewise, encryption with a combination of exclusion keys in AND-fashion as discussed above, will make it possible for all receivers in the group to decrypt the message, except for the excluded receivers. In a preferred and very efficient issuing scheme, an integer basis number b and a dimension number d are chosen. Basis b is greater or equal 2 and typically less or equal 16. Dimension number d is greater or equal 1, and typically ranges from 2 to 20. Details regarding choice of b and d will be discussed with regard to the preferred embodiments. Each group comprises up to a maximum of b^{d} receivers. It is of course preferred that the groups be filled, possibly except for the last one. There are b*d selection keys, out of which each receiver set contains (b−1)*d. These (b−1)*d selection keys are determined by representing a receiver number r in a number system to basis b, and allocating for each digit of the representation one of b predetermined selection keys. This issuing scheme ensures in a quite simple and mathematically precise manner that receiver selection key sets of different receivers in the same group differ by at least one selection key.

For the medium scenario issuing scheme, it is further preferred that the address base key set contains b^{d} address keys, i.e. as many address keys as receivers in the group. Using the above described selection key issuing scheme, a preferred address key distribution can be achieved by transmitting each address key d times, each time encrypted with a different one out of a transmitting combination of selection keys. This transmitting combination is again chosen according to a number representation in a number system to basis b. Together with the selection key issuing scheme discussed above, this ensures that each receiver receives all address keys, except for one, which then becomes his exclusion key.

In the alternative issuing scheme for large scenarios, there are at least two exclusion keys for each receiver in a group. Each combination of exclusion keys is unique within that group. This allows to precisely exclude non-authorized receivers within the group. Further, it is preferred that the groups are subdivided into a plurality of sub-groups. Address keys are accordingly divided into first address keys and second address keys. Receivers in the same sub-group have the same first address keys, but different sets of second address keys. This further subdivision allows a quasi 2-dimensional addressing of receivers within a group. By using first and second address keys, where first address keys address the sub-group and second address keys address an individual receiver within a sub-group, the total number of address keys is significantly reduced.

According to a further development of the large scenario issuing scheme, there is, for each sub-group, one sub-group exclusion key and for each receiver within a sub-group, one position exclusion key. Again, the term position exclusion key refers to the individual receiver's key set (second address keys) and the individual sub-group's key set (first address keys) and designates a key which is not contained in the corresponding receiver/sub-group key set, but is contained in the remaining receiver/sub-group key sets. For exclusion of a non-authorized receiver within a group, an exclusion key is now calculated from the non-authorized receiver's position exclusion key and sub-group exclusion key. The exclusion key is thus a mathematical combination of an individual receiver's sub-group and position exclusion key. This allows to precisely and safely exclude a single receiver. Use of a corresponding pair of exclusion keys can be seen as 2-dimensional addressing of that receiver within its group.

Preferably, the mathematical combination of the sub-group exclusion key and the position exclusion key is calculated by recursive exponentiation, i.e. by calculating the exponentiation of a base with one of the two exclusion keys, and by further exponentiation of the result with the other of the exclusion keys. As will become apparent during discussion of the preferred embodiment, this corresponds to the Diffie-Hellman key establishment procedure

Under special circumstances, namely if the individual results of exponentiation with each of the exclusion keys individually is known, this type of mathematical combination of the exclusion keys may be a reversed (i.e. the message decrypted) if only one out of the two exclusion keys are known. This method therefore effectively implements an OR-relation, such that it will be sufficient to either know the position exclusion key or the sub-group exclusion key to still be able to decrypt the message. Consequently, only the non-authorized receiver, which holds neither one nor the other, will not be able to decrypt the message.

For the large scenario issuing scheme, it is preferred to chose an integer basis number b and an integer dimension number d. b is greater or equal 2, typically be smaller or equal 16. d is greater or equal 1, and typically between 2 and 20. Each group comprises up to a maximum of b²d receivers, and is divided into up to b^{d} sub-groups, each with up to b^{d} receivers. Here again, it is preferred that the sub-groups and groups (except for the last one) are filled up to the maximum. The selection base key set contains 2*b*d selection keys, with b*d first selection keys and b*d second selection keys, out of which each receiver holds (b−1)*d first selection keys and (b−1)*d second selection keys. As explained above with regard to the medium scenario issuing scheme, the combination of keys given to each receiver is determined according to a representation of a receiver number r in a number system to basis b. In the same way, the combination of second selection keys is determined according to a representation of a sub-group number s in a number system to basis b. In a further development, an address base key set with b^{d} first address keys and b^{d} second address keys is used. Each of these address keys is transmitted d-times, each times encrypted with a different one out of a transmitting combination of selection keys. As described above with regard to the medium scenario issuing scheme, the transmitting combination is chosen according to a representation of a key number t in a number system to basis b. This ensures the above described address key issuing scheme, where there is one subgroup exclusion key and one position exclusion key for every receiver within a group. As described above, the accessing means according to the invention, which allow the individual receivers to access their receiver set of keys, need not be implemented as storage means located at the receivers. Instead, it is preferred, as described, that the address keys are themselves selectively transmitted from the sender to the receivers. While it is possible to first transmit the address keys and then transmit the encrypted messages, it is preferred to first transmit the encrypted messages and then the corresponding address keys. In cases where the encrypted messages are quite short, i.e. do not comprise a large number of bits (e.g. if only a multicast key is transmitted) it is easier for the receivers to store one out of the encrypted messages (the one message that is directed to their group), and to then later receive the corresponding address keys, and use them during decryption, without storing them.

In the following, embodiments of the invention will be discussed with reference to the figures, where

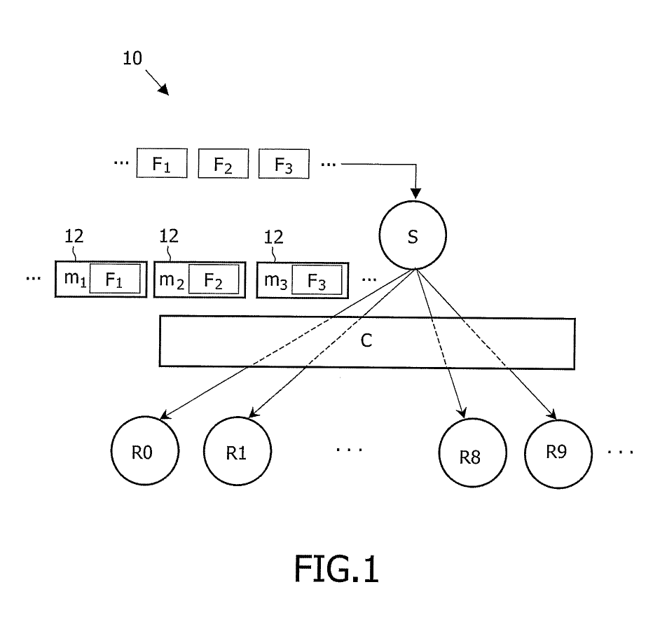

FIG. 1 shows a symbolic representation of an embodiment of a broadcasting system according to the invention;

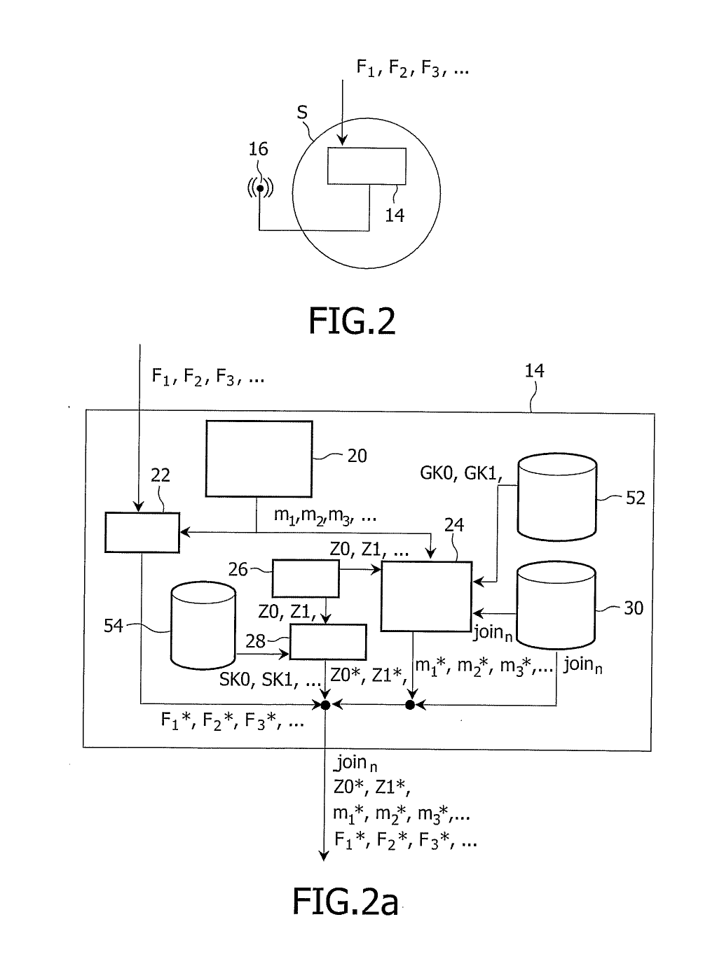

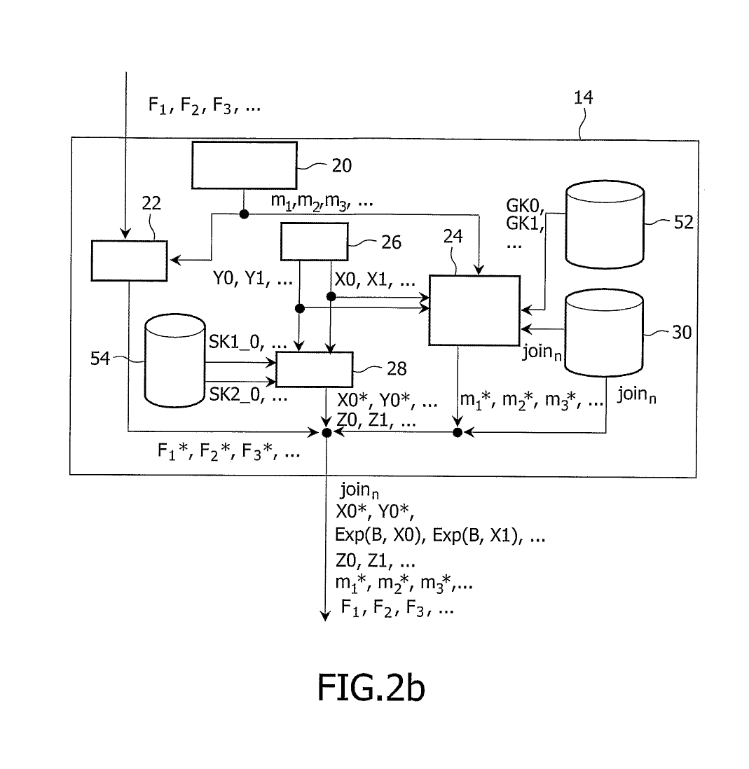

FIG. 2 shows a symbolic representation of a sender of the system shown in FIG. 1;

FIG. 2a shows a symbolic representation of a first embodiment of a processing unit of the sender from FIG. 2;

FIG. 2b shows a symbolic representation of a second embodiment of a processing unit of the sender from FIG. 2;

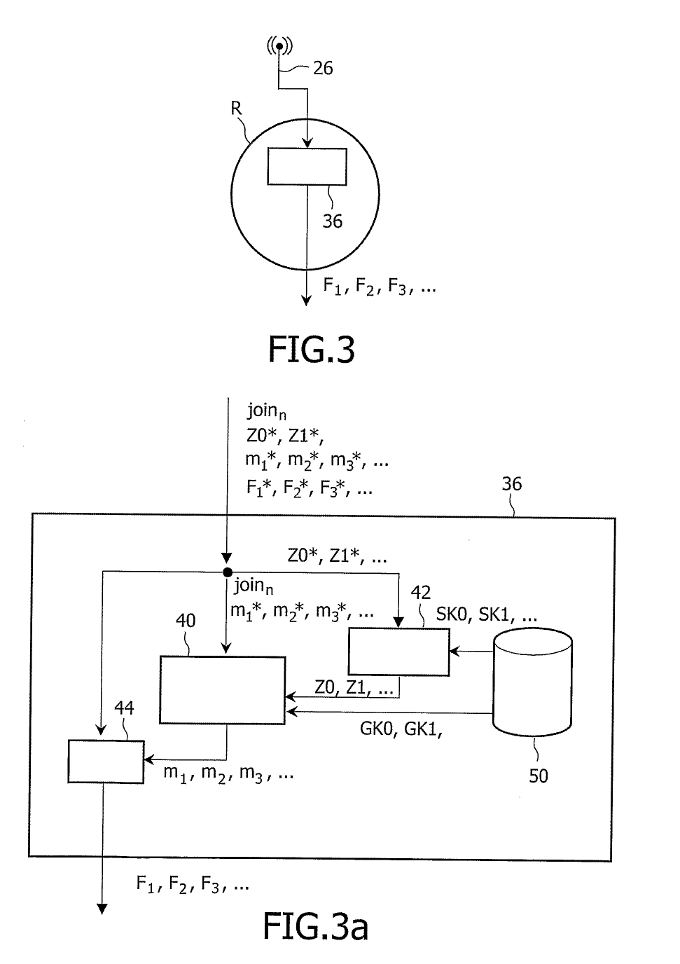

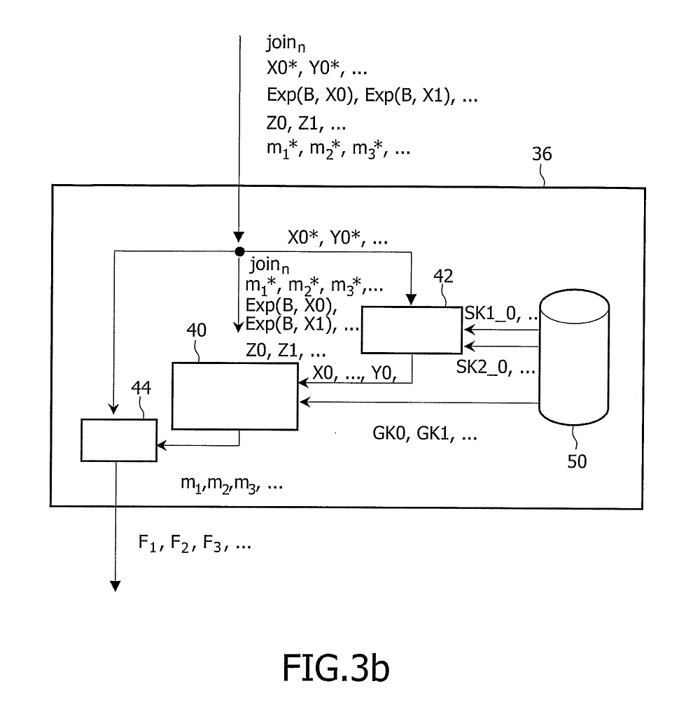

FIG. 3 shows a symbolic representation of a receiver out of FIG. 1, with a processing unit;

FIG. 3a shows a symbolic representation of a first embodiment of a processing unit of the receiver;

FIG. 3b shows a symbolic representation of a second embodiment of a processing unit of the receiver;

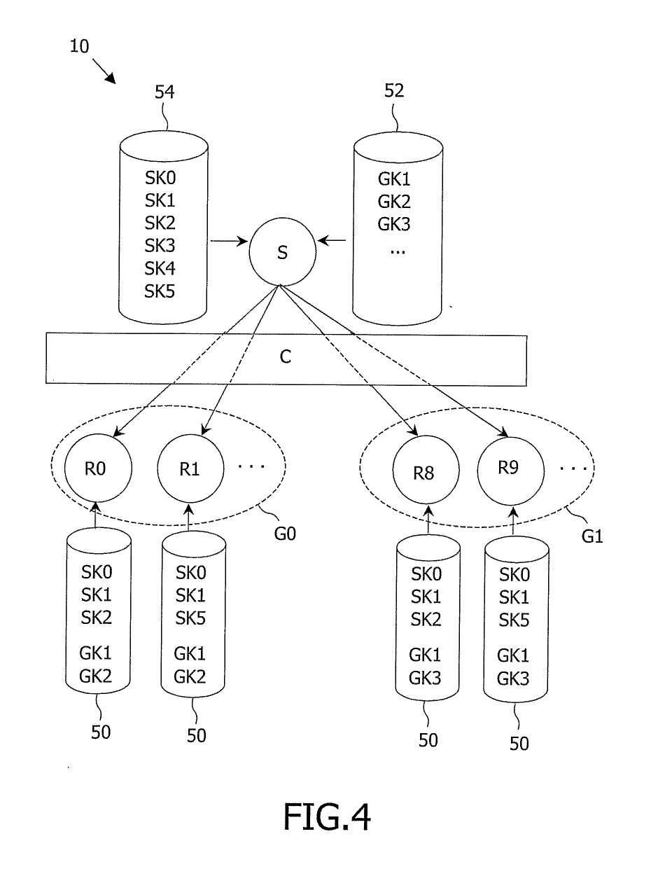

FIG. 4 shows in symbolic representation a key distribution system within the broadcasting system of FIG. 1.;

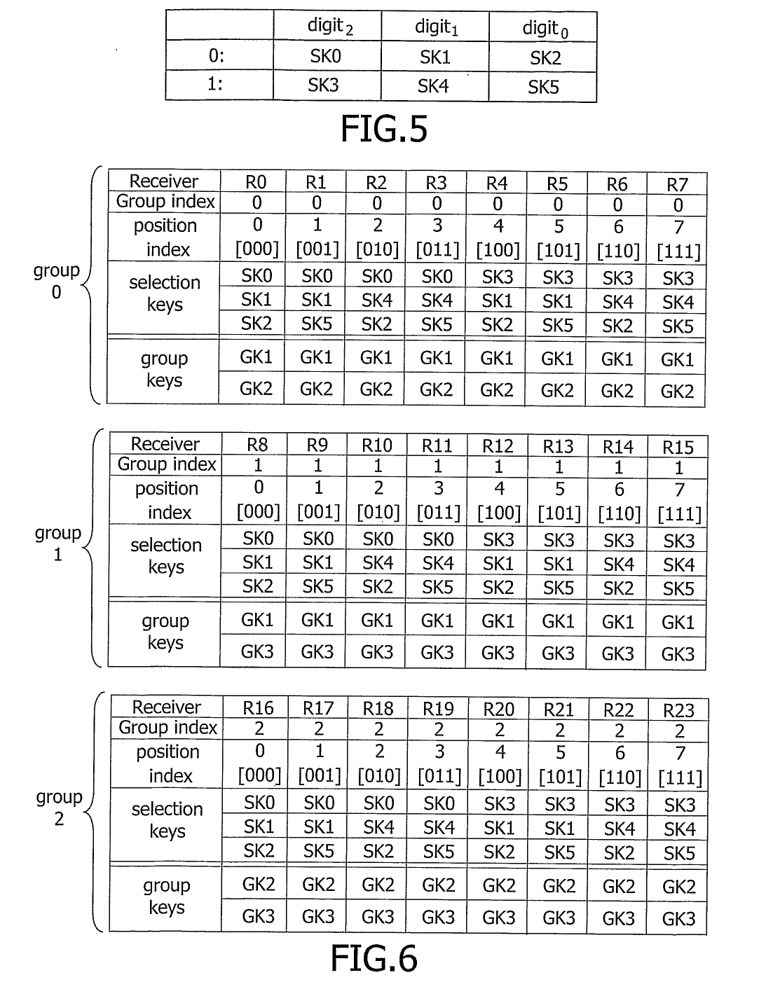

FIG. 5 shows a table showing selection keys representing digits in the number system to base 2;

FIG. 6 shows a table showing a first embodiment of an issuing scheme;

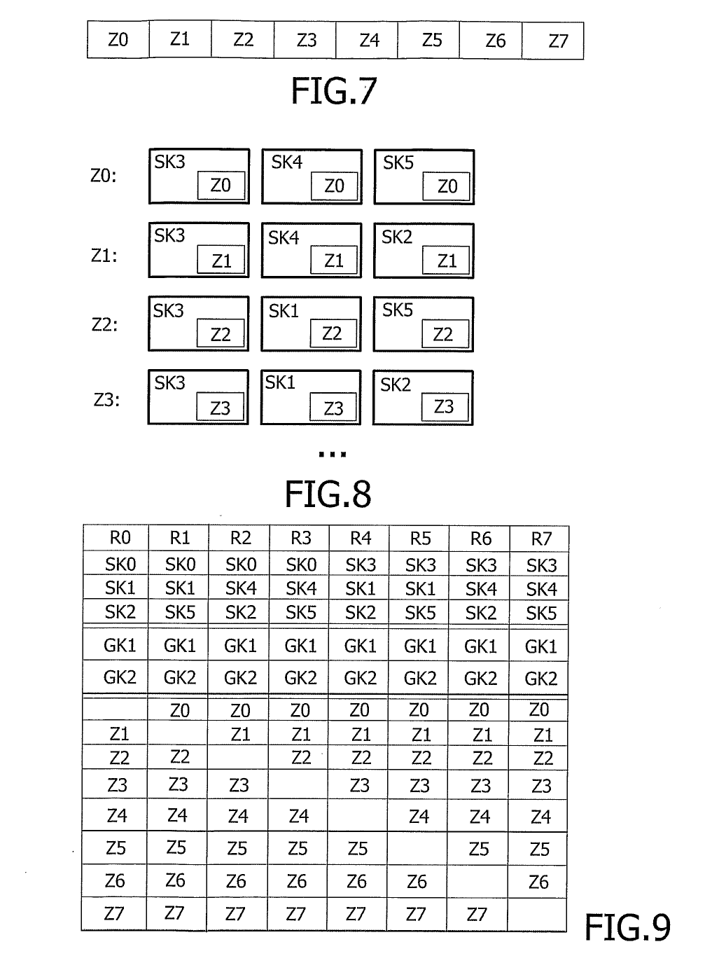

FIG. 7 shows a table showing a set of temporary address keys;

FIG. 8 shows in symbolic representation temporary address keys encrypted with selection keys;

FIG. 9 shows a table with an address key distribution according to the first embodiment of an issuing scheme;

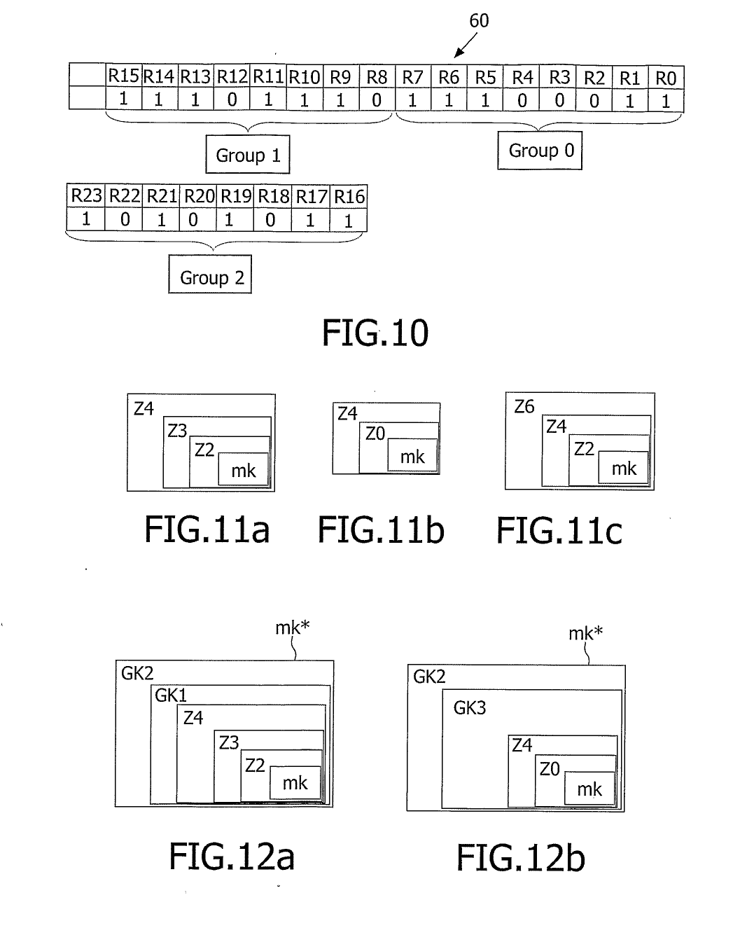

FIG. 10 shows in symbolic representation a joining vector;

FIG. 11a-c show, in symbolic representation, encrypted versions of a multicast key;

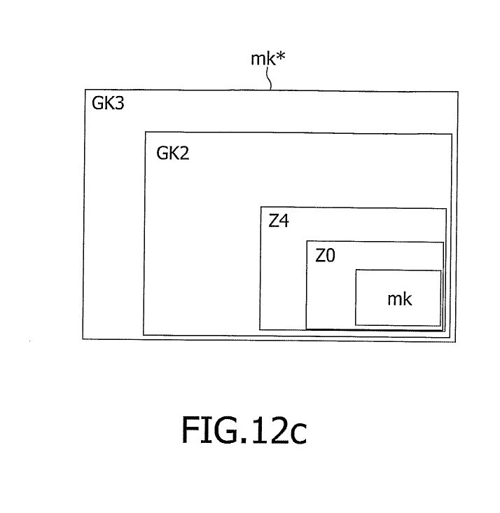

FIG. 12a-12c show, in symbolic representation, encrypted messages including a multicast key;

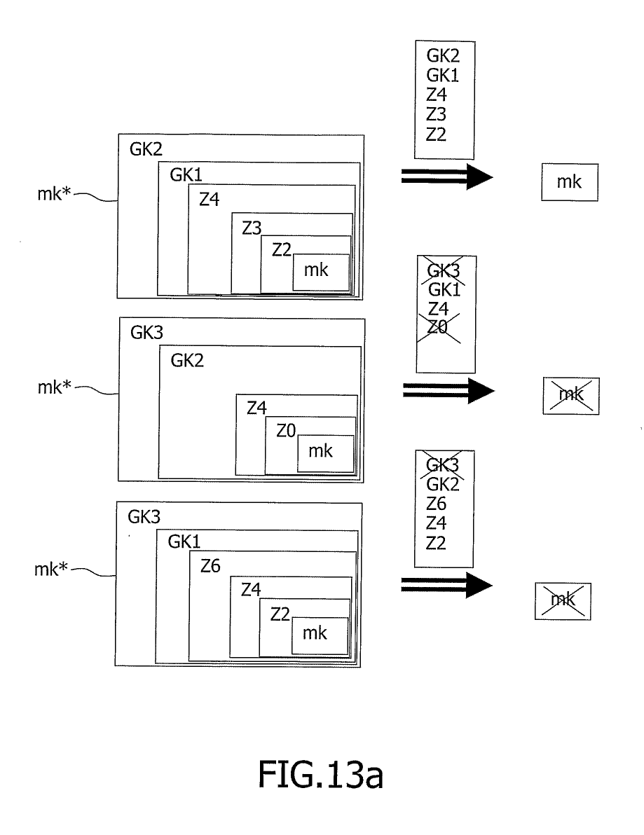

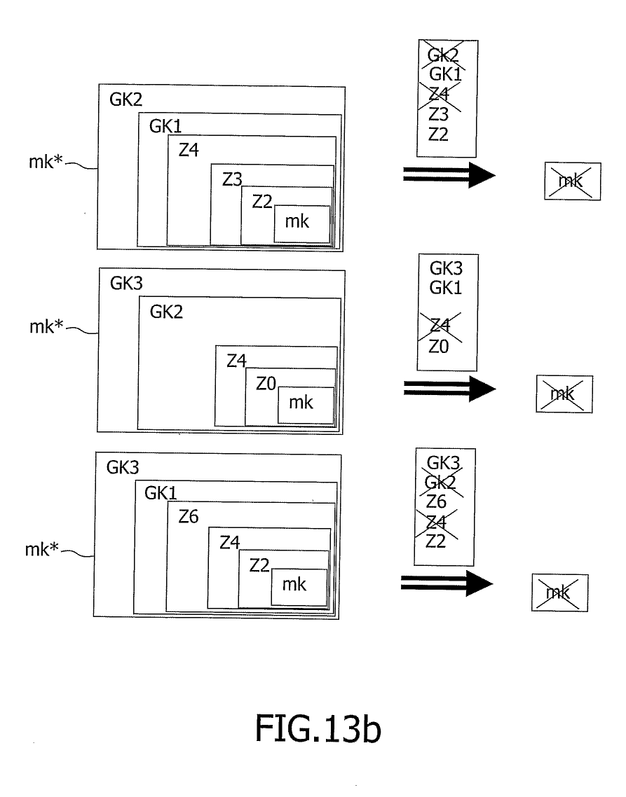

FIG. 13a, 13b show in symbolic representation two examples of processing of the encrypted packages from FIG. 12a-12c;

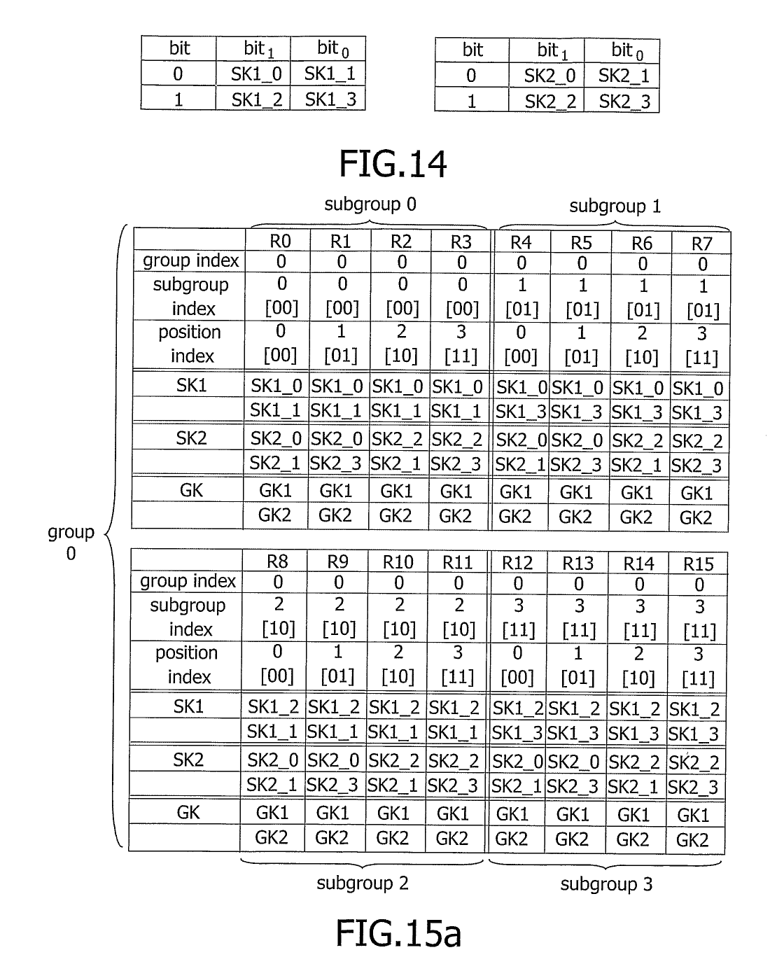

FIG. 14 shows two tables with selection key representing digits in a number system to base 2 according to a second embodiment of the invention;

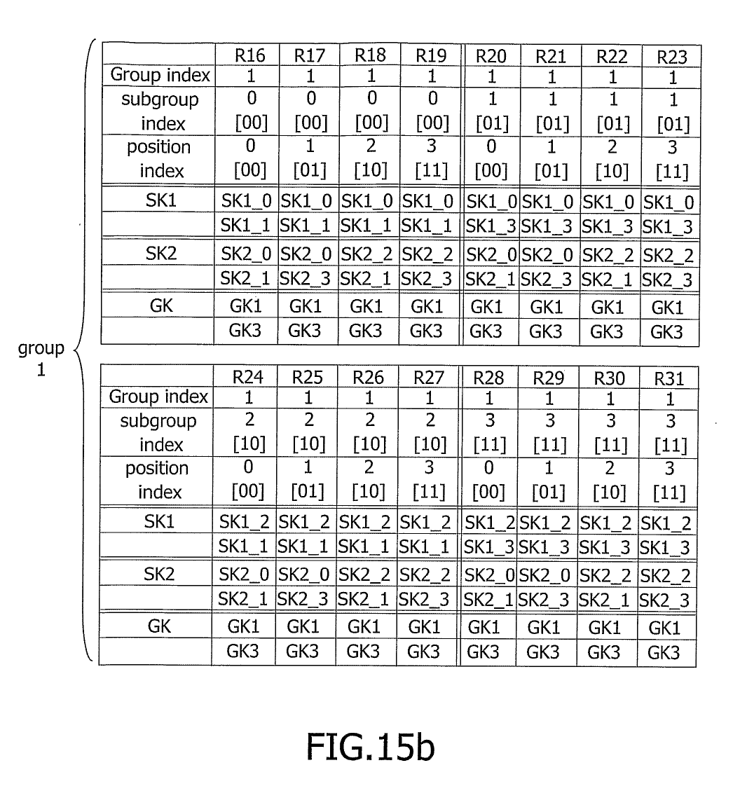

FIG. 15a, 15b show in symbolic representation an issuing scheme according to the second embodiment of the invention with groups and subgroups;

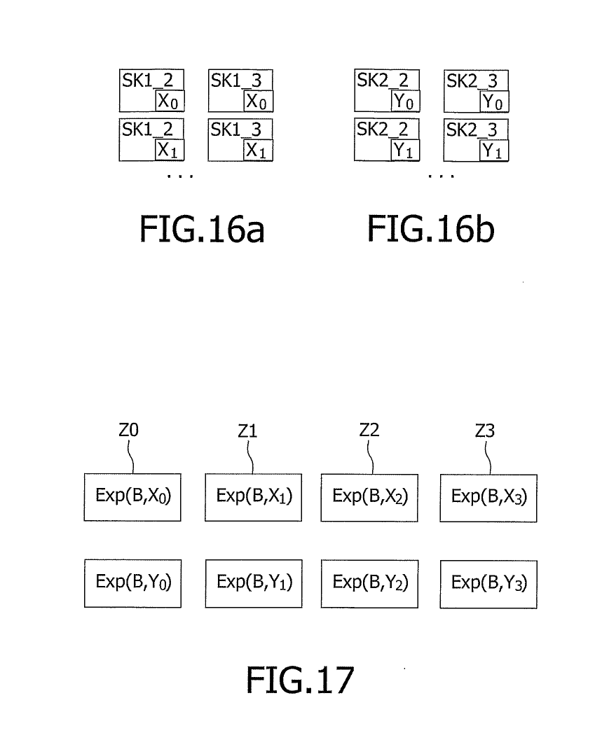

FIG. 16a shows in symbolic representation first intermediate keys encrypted with first selection keys;

FIG. 16b shows in symbolic representation second intermediate keys encrypted with second selection keys;

FIG. 17 shows in symbolic representation auxiliary keys;

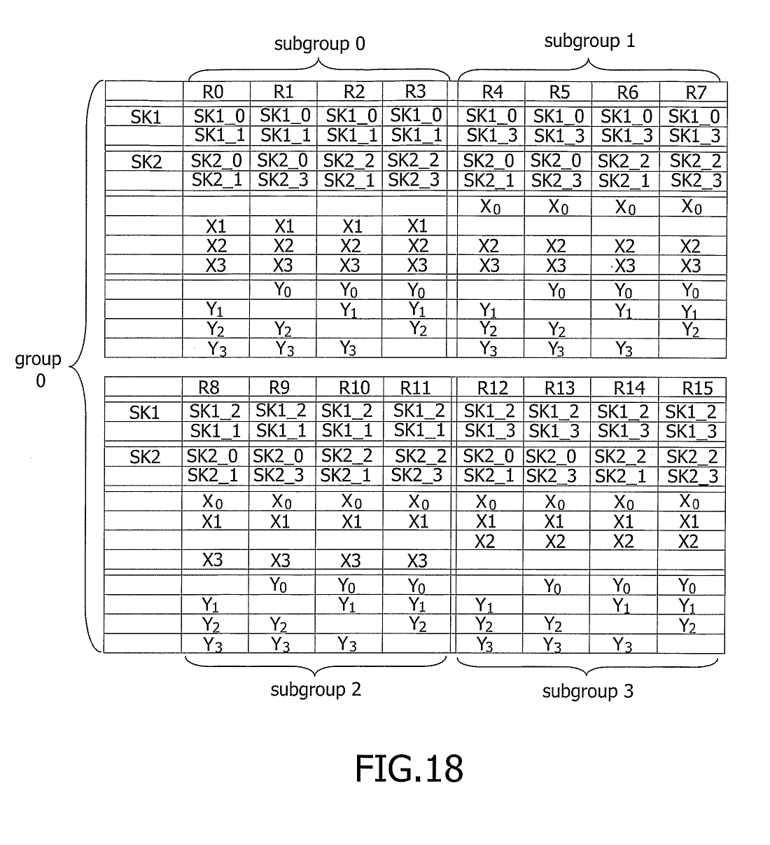

FIG. 18 shows a table with an address key distribution according to the second embodiment;

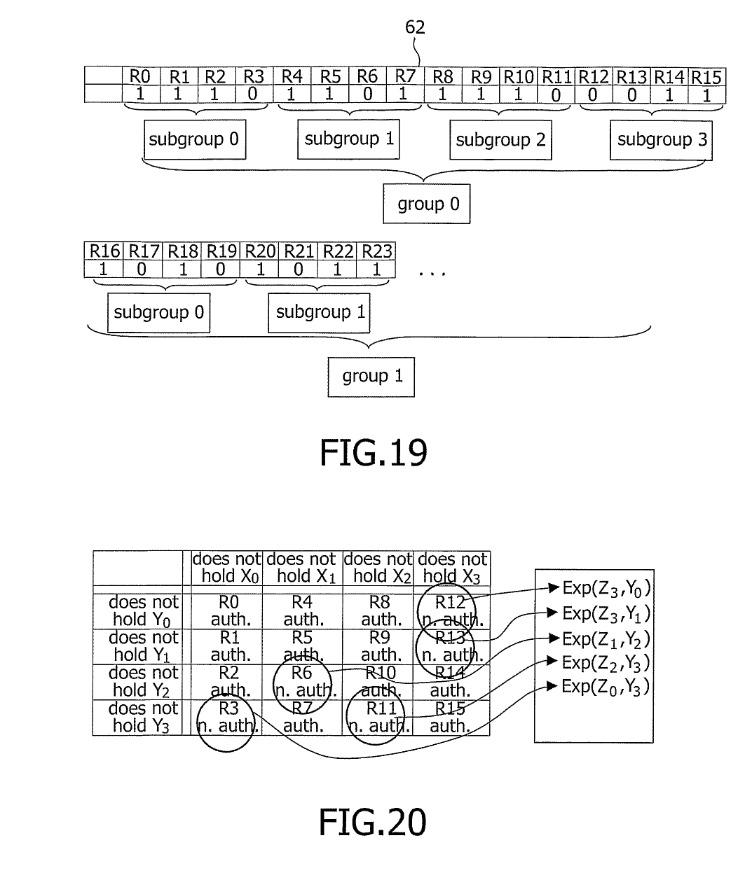

FIG. 19 shows in symbolic representation a joining vector;

FIG. 20 shows a table with excluded receivers;

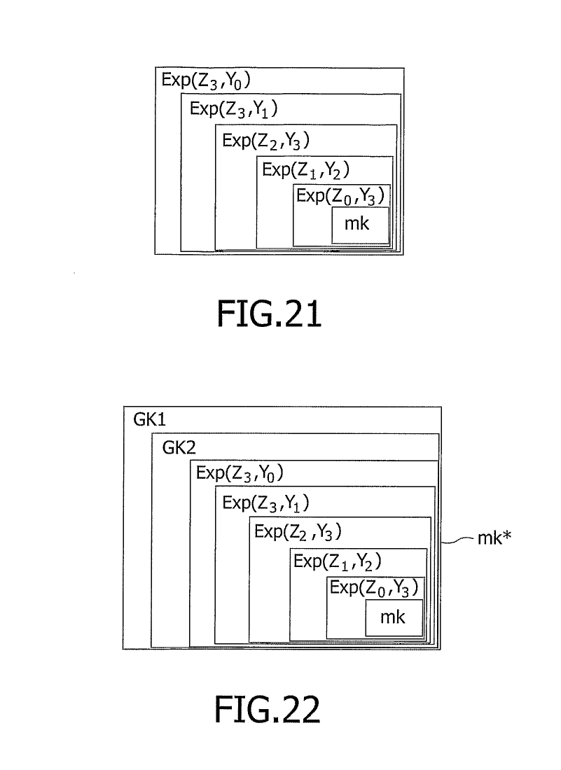

FIG. 21 shows in symbolic representation an encrypted multicast key;

FIG. 22 shows in symbolic representation an encrypted message containing a multicast key;

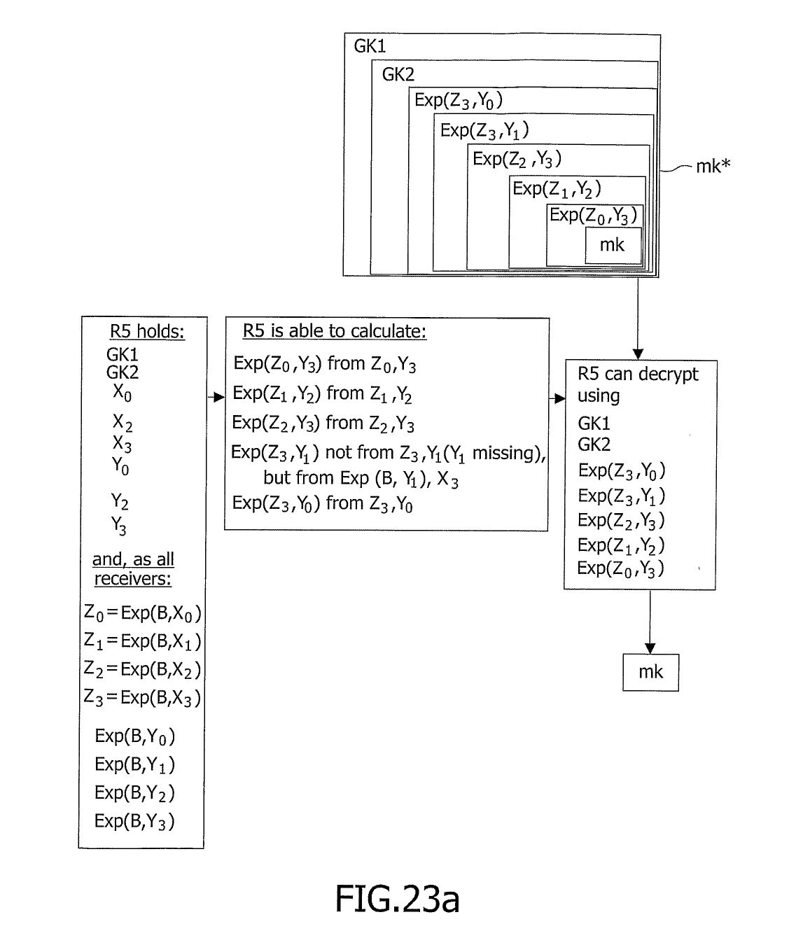

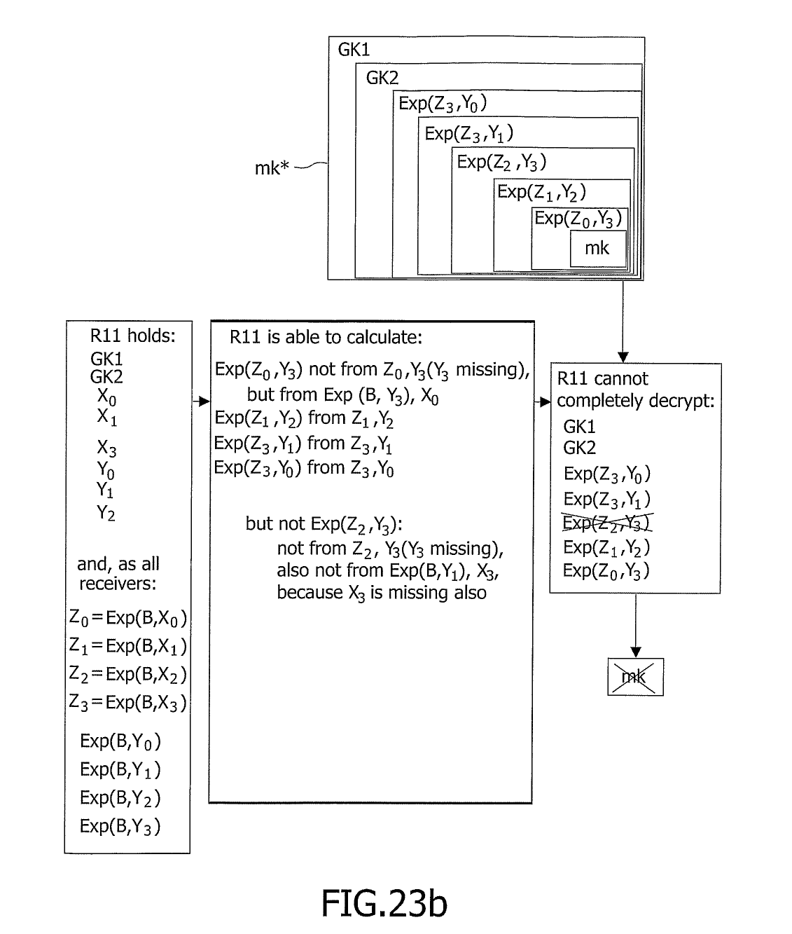

FIG. 23a, 23b show in symbolic representation decryption of the encrypted message from FIG. 22.

FIG. 1 shows a basic broadcasting system 10 according to an embodiment of the invention. The system 10 comprises a sender S and, by way of example, a number of receivers, R0, R1, R8, R9. The sender S is connected to each of the receivers R0, R1, R8, R9 via a channel C, i.e. it can send data to the receivers. Channel C in the present example allows communication only unidirectional from the sender to the receivers. The channel is of such a nature that data sent from sender S can be received at each of the receivers R0, R1, R8, R9. It should be noted that system 10 is a general example, and that channel C can include any type of media and transmission method, like for example radio broadcast over the air, data transmission in a computer network or others.

A content source (not shown) continuously delivers content data F1, F2, F3 . . . to broadcasting sender S. Sender S includes a scrambling unit (not shown), with scrambles content data to scrambled content data 12 using a plurality of scrambling keys (multicast key) ml, m₂, M₃, . . . which are continuously delivered by a multicast key generator (not shown). Broadcasting sender S continuously broadcasts this scrambled content data. The receivers R0, R1, R8, R9 on the other hand each include a de-scrambling unit and a multicast key storage, as will be discussed below.

For the scrambling and de-scrambling operation generally any type of encryption method may be used. It is preferred to use a fast block cipher. In the examples that will be discussed below, we assume a block size and a key size of equally 128 bits.

Broadcasting system 10 could be, for example, a pay-TV system where TV content is continuously broadcast in scrambled form, and only subscribing users (authorized receivers) should be able to view the content. The system is adapted to be highly dynamic, so that e. g. pay-per-view is possible. Therefore, the scrambling key (multicast key) is changed quite often over time, e. g. every minute.

The actual TV content data F1, F2, F3 . . . delivered is continuously scrambled using the multicast keys valid a different points in time.

In parallel to the scrambled broadcasting of broadcasting sender Sb, sender S continuously distributes the multicast keys valid at any given time to the authorized receivers.

FIG. 2 shows a symbolic representation of a sender S from FIG. 1. The sender comprises a processing unit 14, which receives the content data F1, F2, F3. The processing unit 14 scrambles the data and broadcasts it over channel C by use of a transmission means 16, which can be any type of broadcasting sender, e.g. a radio transmitter or a computer network interface. The processing unit also generates and distributes the multicast keys. FIG. 3 shows in symbolic representation a generic receiver R. The receiver R has a reception means 26 for receiving data on channel C. The received data is processed in a processing unit 36.

The specific configuration of the processing units of both sender and receiver is dependent on the specific embodiment. As will be explained below, FIGS. 2a, 3a show details of processing units according to a first embodiment, and FIG. 2b, 3b according to a second embodiment.

At the sender S, authorization information is available about authorized and non-authorized receivers. In the following, two embodiments will be explained, in which the processing unit 14 of sender S encrypts content data F1, F2, F3, . . . such that processing unit 36 at authorized receivers R may decrypt the data, but non-authorized receivers may not.

### FIRST EMBODIMENT

The first embodiment of the invention is aimed at medium sized scenarios, with approximately 100 up to 100,000 receivers. The basic structure of a corresponding system is shown in FIG. 4. The receivers are divided into groups G0, G1, . . . Each receiver has an associated key memory 50. The sender has a group key memory 52 and a selection key memory 54.

The actual encryption algorithm used will not be further discussed here. In embodiments of the invention, virtually all encryption algorithms known to the skilled person may be used. We will only generally define encryption and decryption operation in the following way:
Encryption
   Enc(K, M)=C
Decryption
   Dec(K, C)=M

Group key memory 52 comprises group keys GK1, GK2, GK3, . . . Group keys are used to direct encrypted transmissions to a specific group. While it is possible to assign each group a single, unique group key, it is preferred as shown in FIG. 4, that group key memory 52 comprises a group key base set, and the members of each group hold the same, unique combination of these group keys. For example, in FIG. 4 the members of group G0 all hold group keys GK1, GK2, while members of G1 all hold GK1, GK3. Thus, a message recursively encrypted e.g. with both GK1 and GK2 can only be decrypted by members of group G0.

The selection keys stored in selection key storage 54 at sender S form a base set of selection keys SK0, SK1, . . . SK5. Within each group G0, G1, each receiver holds a unique combination of three selection keys. However, the combinations of selection keys held by receivers in different groups are identical, i.e. the first receiver R0, which is the first member of first group G0 holds the same sets of selection keys as the first receiver R8 from group G2, and as the first receiver from any further group.

Generally, for establishing a multicast system for a total number N of receivers, integer numbers b and d are chosen, where b>=2 is a basis number and d>=1 is a dimension number. The receivers are grouped in groups of size b^{d}. The issuing scheme (i.e. which receiver can access which combination of keys) of selection keys within the groups is determined according to a representation of a receiver number in the number system to the basis b. For a mathematical definition of the issuing scheme, we will use the following definitions:

Let N, N₀ denote the set of natural numbers without or including 0, respectively. For a set S, let P(S) denote the power set (set of all subsets of S). We define the following maps from N₀ to P(N):

f_{G}: List all subsets of N of size g in lexicographical order (where sets are read as decreasing sequences). Example: for g=2 this yields the list {1, 2}, {1, 3}, {2, 3}, {1, 4}, {2, 4},{3, 4}, {1, 5}, . . . This defines a mapping f_{G}: N₀→P(N) (in the example: f_{G}(0)={1, 2}, f_{G}(1)={1, 3}, . . . )

digits (n): Let n>0 be presented in the number system to the basis b and let digitᵢ (n) denote the ith digit (counted from the right, beginning with 0), examples: for b=3 we have digit₂ (15)=1 and digit₃ (15)=0. In other words:

$${digit}_{i} ( n ) := ⌊ \frac{n}{{b}^{i}} ⌋ \% b ,$$

(% denotes the modulo operation, └·┘ is integer truncation)

f_{S}: Let f_{S}(n) :={1+i·b+digitᵢ(n)|i=0 . . . d−1}

f _{S̅}: Let f _{S̅}(n):={1, 2 . . . , b*d}\f_{S}(n) (where denotes the set difference operation)

Note that f_{G} is injective (by construction) and that both f_{S} and f _{S̅} are injective maps from {0, . . . , b^{d}−1} to P({1, . . . , b d}).

Using these definitions, the issuing scheme may now be defined. Assume that indices n from 0 to N−1 are uniquely assigned to the receivers, then the key issuing scheme is described by the following rule:

The receiver with index n obtains all group keys GKᵢ with

$$i ∈ {f}_{G} ( ⌊ \frac{n}{{b}^{d}} ⌋ )$$

and all selection keys SKᵢ with i∈f _{S̅}(n⁰/₀b^{d}).

Authorization information about the receivers is summarized in a joining vector, which contains an entry for every receiver in the system, where the entry is either “0” for non-authorized receivers or “1” for authorized receivers.

In a system with a selection and group key issuing scheme as defined above, a message (in this case copies of the multicast keys mₗ, m₂, m₃, . . . ) is sent to all authorized receivers by using the following algorithm:

Given an arbitrary joining vector (joinₙ)ₙ₌₀ . . . N−1∈{0, 1}^{N}, transmit the information of an m-bit multicast key mk as follows (where every “send” represents a broadcast over the open channel):

| | |
|---|---|
| 1. | Send join₀, join₁, ... join_{N-1}; |
| 2. | $Generate {b}^{d} random m \text{-} bit sequences {Z}_{0} , {Z}_{{b}^{′ /}} {,}_{- 1} ;$ |
| 3. | $FOR i = 0 … ⌊ \frac{N - 1}{{b}^{d}} ⌋ DO$ |

{

$M ← mk ;$
FOR j = 0... b^{d}− 1 DO

$IF ( j + i \cdot {b}^{d} < N ) AND ( ! {join}_{j + i \cdot {b}^{d}} ) THEN M ← M ⊕ {Z}_{j} ;$

FOR k ∈ f_{G} (i) DO (in increasing order)

$M ← Enc ( {GK}_{k} , M ) ;$

Send M;

}

| 4. | FOR j = O...b^{d} − 1 DO |
|---|---|
| | FOR k ∈ fₛ (j) DO (in increasing order) |

Send Enc(SK_{kl , Z}ⱼ);

The algorithm is based on dividing the users into groups of size b^{d}. Further to the group keys GK and selection keys SK permanently stored at the receivers, random bit sequences Z acting as temporary address keys are used for encryption. A copy of the multicast key is sent for each group individually, after a bitwise exclusive or with an exclusion key for all non-joining users in the group and after encrypting the result with all corresponding group keys. The address keys Zⱼ are sent d times, each time encrypted with one of the selections keys according to the digits of j in the number system to the basis b.

A receiver with index n will be able to reconstruct mk out of the broadcasted stream if and only if joinₙ=1.

FIG. 2a shows the corresponding structure of processing unit 14 at the sender S. A multicast key generator 20 successively generates multicast key m₁, m₂, m₃, . . . Content data F1, F2, F3, . . . is scrambled in a scrambling unit 22 using the multicast keys valid at different points in time. Scrambled content features F1*, F2*, F3*, . . . are broadcast.

In parallel, multicast keys m₁, m₂, m₃, . . . are encrypted by encryption unit 24 according to joining information delivered from an authorization storage means 30. The encrypted multicast keys m₁*, m₂*, m₃*, . . . are broadcast.

Encryption unit 24 uses for encryption group keys GK0, GK1, . . . and address keys Z0, Z1, . . . , which are for each encryption of a multicast key newly generated at random by address key generator 26. Address keys Z0, Z1, . . . are random bit sequences of the same length as the multicast key, e.g. 128 bit. These address keys are encrypted by a key encryption unit 28 with selection keys SK0, SK1, . . . delivered from selection key storage 54. The encrypted address keys Z0*, Z1*, . . . are broadcast.

At the receiver side, the broadcast data is received, and authorized receivers extract content data information F1, F2, F3, . . . from it. The corresponding structure of processing unit 36 of a receiver R is shown in FIG. 3a. The received encrypted address keys Z0*, Z1*, . . . are decrypted in a key decryption unit 42, using the available selection keys SK0, SK1, . . . delivered from selection key storage 50. The thus decrypted address keys Z0, Z1, . . . are used in a multicast key decryption unit 40 to decrypt the encrypted multicast keys m₁*, m₂*, m₃*, . . . The thus decrypted multicast keys m₁, m₂, m₃, . . . are used in a descrambling unit 44 to descramble scrambled content data F1*, F2*, F3*, and to obtain cleartext contend data F1, F2, F3, . . .

Reception and decryption of joining information, encrypted address keys and encrypted multicast keys at the receiver side are effected according to the following algorithm:

$⌊ \frac{n}{{b}^{d}} ⌋ ;$

| | |
|---|---|
| 1. | $h ← \qquad s ← n \% {b}^{d} ;$ |
| 2. | ${join}_{h \cdot {b}^{d}} , {join}_{h \cdot {b}^{d} + 1} , … , {join}_{( h + 1 ) \cdot {b}^{d} - 1} ( ignore all the other bits sent ) ;$ |
| 3. | $FOR i = 0 … ⌊ \frac{N - 1}{{b}^{d}} ⌋ DO$ |

$Get tmp ; IF ( i = h ) THEN M ← tmp ;$

| | |
|---|---|
| 4. | FOR k ∈f_{G} (h) DO (in decreasing order) |

$M ← Dec ( {GK}_{k} , M ) ;$

| | |
|---|---|
| 5. | FOR j = 0...b^{d} − DO |

{
$Z ← 0$
FOR k ∈f_{S} (j) DO (in decreasing order)
{

Get tmp;
$If ( Z = 0 ) AND ( k ∈ {f}_{\overline{S}} ( s ) ) AND ( j + h \cdot {b}^{d} < N ) AND ( ! {join}_{j + h \cdot {b}^{d}} )$

$THEN Z ← Dec ( {SK}_{k} , tmp ) ;$

}
$If ( Z \neq 0 ) THEN M ← M ⊕ Z ;$
}

| | |
|---|---|
| 6. | $mk ← M ;$ |

In step 2. and 3., the information relevant to the receiver's group h is filtered out of the stream of data. Step 4. reverses the encryption with group keys and in step 5, the random bit sequences are recovered and subtracted for all nonjoining group members. The result is the original multicast key.

A receiver n with joinₙ=0, has no chance of recovering Z_{S} with s=n% b^{d} (except by attacking the encryption altogether) because he lacks all fitting selection keys. Since for a non-joining receiver n the message is recursively encrypted with the random bit sequence Z_{S} (in the given, simple implementation by XOR) acting as an exclusion key, the excluded receiver will not be able to gain any information on the multicast key mk from the transmission corresponding to his own group. For all other groups, at least one of the group keys is missing to him, so there is no way of getting information, either.

After the general structure of encryption and decryption of the multicast key to achieve selective multicast have thus been explained, a specific example of the first embodiment will be discussed with reference to FIG. 5-13a, 13b:

In the following example, the parameters of the system are chosen to be basis b=2 and dimension d=3. We will consider only the first three groups, with a total number of 24 receivers, since each group has b^{d} (8) members. It should be noted, that the example is purposely chosen to comprise only a small number of receivers, in order to be able to demonstrate operation of the system. In actual practice of the invention, the number of receivers will generally be higher. Choice of the internal parameters will be discussed below. In the table of FIG. 6, the issuing scheme with selection keys and group keys for all 24 receivers is given. As already mentioned, the distribution of selection key within each of the three groups is identical.

Since basis b was chosen to be equal to 2, each receiver number (position index) may be written in a dual representation (number system to basis 2) to determine the selection key issuing scheme. As shown in FIG. 5, for each digit of the receiver number in dual representation, exactly one selection key is assigned to value “0” and a different one for value “1”. The selection keys in each group are distributed according to this representation.

Now, for each step of transmission of a multicast key, random bit sequences Z0, . . . Z7 are generated, which are used as temporary address keys. It should be noted that these temporary keys here are used only for a single transmission. Alternatively, it would be also possible to use the temporary keys for multiple transmissions.

If the address keys Z0, . . . Z7 are transmitted to the receivers according to step 4 of the above given sending algorithm, this leads to sending of encrypted packages as shown in FIG. 8. Each address key is send d times (here, d=3), each time encrypted with a different selection key SK. For encryption of the address key with the index j, only selection keys are used which the receiver with index j does not hold.

FIG. 9 shows the distribution of address keys that is achieved by the described encryption. As shown in the table, for each receiver in each group, there is exactly one exclusion key. For example, the exclusion key Z0 may be use to exclude receiver R0, because R0 is the only receiver within the group that cannot access Z0. The same applies to R1 and Z1, and so on.

It should be noted here, that in the implementation according to the above given sending and receiving algorithms, the table of FIG. 9 does not reflect key storage at the receivers, but the ability of receivers to access individual address keys during execution of the algorithm. Although it may be present in an alternative embodiment, the above given sending and receiving algorithms do not include storage of address keys at the receivers. Instead, as the skilled person will appreciate, the address keys are received “just in time” for use during decryption and need not be stored, which further minimizes storage requirements on the receiver side.

In the example, let us assume a joining vector 60 as shown in FIG. 10. The “1” and “0” entries next to the receivers reflect which of the receivers are authorized to receive the multicast key. For example, in group 0, receivers R0, R1, R5, R6 and R7 are authorized to receive the multicast keys, while R2, R3 and R4 are not.

Now, during encryption (step 3 of the sending algorithm), encrypted versions of the multicast key mk are calculated. The encryption algorithm proposed here is a simple XOR with the address keys, but of course more sophisticated algorithms may be used. For each group, the multicast key is thus encrypted with the exclusion keys of the non-authorized receivers. For example, FIG. 1 la shows encryption of a multicast key mk for group 0, with address keys Z2, Z3 and Z4 (i.e. exclusion keys for non-authorized receivers R2, R3, R4) used for encryption. Accordingly, FIG. 11b and 11c show the encrypted multicast keys for groups 1 and 2, respectively. The thus recursively encrypted multicast key for each group is finally encrypted with all group keys of that group. FIG. 12a-12c show the corresponding encrypted multicast keys mk* for groups 0, 1, 2, respectively.

Reception and decryption of the encrypted multicast key mk* at the receivers will now be demonstrated with reference to FIG. 13a, 13b, where FIG. 13a corresponds to decryption at receiver R0 (which has a “1” entry in joining vector 60, and is therefore authorized to receive the multicast key) and receiver R12 (which has a “0” entry in joining vector 60, and is therefore not authorized to receive the multicast key):

Receiver R0 may access, as discussed above with regard to FIG. 9, both group keys GK1, GK2, of its group and all address keys accept for his own exclusion key Z0. Receiver R0 can thus access all address keys Z2, Z3, Z4 used in encryption of the first encrypted multicast key package mk*, and can recursively decrypt mk* to receive the cleartext of mk. It should be noted, however, that receiver RO will not be able to decrypt any of the other mk* packages designated for the remaining groups, because the receiver lacks at least one group key (GK3).

As shown in FIG. 13b, receiver R12 cannot decrypt the first and third encrypted multicast key packages mk* because of missing group key GK2. However, receiver R12 also cannot decrypt the second package mk*, because the recursive encryption includes his exclusion key Z4. Thus, receiver R12 is not able to obtain multicast key mk.

In the following, we will look at resources required for operation of the above system, depending on the number of potential users N, the key and block size m and internal parameters g (number of group keys held by each receiver) b (basis), and d (dimension).

| | server side | user side |
|---|---|---|
| base keys | $b \cdot d + O ( \sqrt[g]{\frac{g ! \cdot N}{{b}^{d}}} )$ | (b − 1) d + g |
| broadcast bandwidth | $N + m \cdot ( d {b}^{d} + ⌈ \frac{N}{{b}^{d}} ⌉$ | |
| [bits] | | |
| work space [bits] | N + m(1 + b^{d}) | 2m + b^{d} |
| random bits | m · b^{d} | 0 |
| exponentiations | α m N | ≦ mb^{d}(αmb^{d} on the aver.) |
| en/decipherings | $g \cdot ⌈ \frac{N}{{b}^{d}} ⌉ + d \cdot {b}^{d}$ | ≦ g + b^{d} (g + αb^{d} aver.) |
| [blocks] | | |

The “broadcast bandwidth” gives the number of bits that are have to be broadcasted. In “work space”, the memory requirements for the variables used in the protocol is given. The last two rows contain the parameter a denoting the rate of non-joining users (so α∈[0, 1], α=0 if all users join, and α=1 if none of the users is joining). In the user side column, we give in the last two rows worst case limits and expectation values (averaged over all users) for the computational effort.

The proposed protocol leaves some freedom with respect to adjusting the free parameters (b, d, g). This can be done in various ways, depending on which resource (compatational demands, storage elements, bandwidth) are supposed to be optimized. Another essential decision is, which of parameters should be kept fixed while the number of subscribed users N varies. Note that when increasing b, d and g (or any subset of them) due to increasing number of potential users, it is necessary to update the sets of keys possessed by existing users, accordingly. However, if the indices of users are reorganized in an appropriate way, it is possible to make sure that every user may keep the keys he already possesses. Like that, only a relatively small amount of incremental keys has to be handed out to the already existing users.

The first embodiment is primarily directed to scenarios (e.g. services for wireless mobile devices) where the maximal number of users per access point is limited for other reasons, anyway. Furthermore, in these situations, the costs for individual communication (i.e. over non-broadcast, secure channels) should be considered comparably high. Besides from that, the demands on computational capabilities and memory consumption on device side are critical factors.

Thus we propose here to select fixed parameters g, d and b, chosen in way to simultaneously optimize bandwidth and number of base keys to be issued to users. Like this, only new users have to receive base keys during subscription but no key substitutions or incremental keys deliveries have to take place for existing users during the whole lifetime of the multicast service.

The parameter g affects the number base keys per user and the number of keys to be stored on server side in contrary directions (see first row in table 1). Since the memory consumption at server side is not critical (say for N<10⁶), this parameter should be set to the lowest possible value g=1.

The optimal choice for b and d is not so obvious. Given an upper bound K to the number of base keys per user i.e. under the constraint (b−1)d+1<K, one has to optimize the transmission effort, i.e. to minimize

$$d \cdot {b}_{d} + ⌈ \frac{N}{{b}^{d}} ⌉ .$$

For a maximal number of potential users N ranging form 10000 to 40000 and K=12 (base keys for each receiver), one finds out that the optimal solution to the above mentioned optimization problem is b=4, d=3. Using these values, together with g=1 and m=128, leads to the following requirements (for simplicity we assume that N is a multiple of 64):

| | server side | user side |
|---|---|---|
| basekeys | 12 + N/64 | 10 |
| broadcast bandwidth (bits) | 3N + 24576 | |

For N<2¹⁶ we may thus state that the protocol allows secure multicast with the following properties:
maximally 1036 base keys in total, 10 base keys issued per user,
extremely small footprint implementation at device side possible: required working space (including base keys) less than 200 byte, at most 65 block decipherings per multicast key establishment,
bandwidth requirement: 160 bytes per user over secure channel (for key issuing), at most 27 kb over broadcast channel (per multicast key establishment).

Roughly speaking, the proposed choice of internal parameters leads to a broadcast bandwidth consumption of 3 bits per potential user. As an example for a typical application let us consider wireless MP3 streaming (at 128 kbit/s): the overhead produced by the protocol for newly establishing a multicast key every two minutes is 1.4% for maximally 2¹⁶ subscribers per access point (and accordingly less for smaller numbers).

In the following, a second embodiment of an implementation of a multicast system and a corresponding issuing scheme will be described. The issuing scheme and algorithm according to the second embodiment are directed to large multicast scenarios, where more than 1,000 receivers are present generally more than 10,000, and preferably the number of receivers is above 100,000.

In the algorithm, the well known Diffie-Hellman protocol will be used. The Diffie-Hellman protocol has been invented for establishment of a cryptographic key between two persons over an open channel without leaving others the chance to get the key. It is based on the simple exponential rule
(a^{b})^{c}=(a^{c})^{b},
generalized to the finite field over a large prime p. The security of the protocol relies on the observation that the discrete logarithm (the inverse function to exponentiation modulo p) is computationally hard for large p (“trap-door function”). In other words, even when knowing a^{b} mod p, a and p, it is practically impossible to gain information on b.

We use the Diffie-Hellman principle in the form of the following function “Exp”, mapping two mn-bit sequences to one m-bit sequence:
Exp(A, B):=A^{B0}/₀p.

Here, the bit sequences A and B are read as a numbers modulo p, the result of the exponentiation is reduced to a number in {0, . . . , p−1} and interpreted as a bit sequence. The pre-chosen number p is assumed to be fixed throughout this note. It should be a prime that is slightly smaller than 2^{m} (e.g. randomly selected between 2^{m}−2^{m/2} and 2^{m}), with m being the number of bits in the multicast key to be transmitted.

The exponential rule implies Exp(Exp(A, B), C)=Exp(Exp(A, C)B); which is used in the following way in the disclosed protocol: If Exp(A, B) and Exp(A, C) are published, a user knowing either B or C will be able to compute Exp(Exp(A, B), C), but a user knowing neither A nor B will not. The Diffie-Hellman protocol may thus be used to implement an OR-relation between two keys.

In the second embodiment the protocol uses two types of issued base keys: group keys GK₁, GK₂, . . . and two sets of b·d selection keys SK1_1, SK1_3, . . . , SK1_b*d and SK2_1, SK2_2, . . . , SK2_b·d. The number of required group keys g depends on the total number of receivers N and the number of groups. Assume that indices from 0 to N−1 are uniquely assigned to the receivers, then the key issuing scheme is described by the following rule:
The user with index n obtains all group keys GK, with

$$i ∈ {f}_{G} ( ⌊ \frac{n}{{b}^{2 d}} ⌋ )$$

and all first
selection keys SK1_i with

$$i ∈ {f}_{\overline{s}} ( ⌊ \frac{n \% {b}^{2 d}}{{b}^{d}} ⌋ )$$

and all second selection keys SK2_i with i∈f _{S̅}(n% bd).

At the sender side, the following algorithm is used to transmit data:

| 1. | Send join₀, join₁, ... join_{N-1} (in compressed form); |
|---|---|
| 2. | $Generate 2 {b}^{d} + 1 random m \text{-} bit sequences B , {X}_{0} , … , {X}_{{b}^{d} - 1} , {Y}_{0} , … , {Y}_{{b}^{d} - 1} ;$ |
| | FOR j = 0 ... b^{d} − 1 DO |

${Z}_{j} ← Exp ( B , {X}_{j} ) ;$

| 3. | $FOR i = 0 … ⌊ \frac{N - 1}{{b}^{2 d}} ⌋ DO$ |
|---|---|
| | { |

$M ← mk ;$
FOR j = 0 ... b^{d} − 1 DO

FOR k = 0 ... b^{d} − 1 DO

$IF ( {ib}^{2 d} + {jb}^{d} + k < N ) AND ( ! {join}_{{ib}^{2 d} + {jb}^{d} + k} ) THEN$

$M ← ENC ( Exp ( {Z}_{j} ; {Y}_{k} ) , M ) ;$

FOR k ∈ f_{G} (i) DO (in increasing order)

$M ← Enc ( {GK}_{k} , M ) ;$

Send M;

}

4. FOR j = 0 ... b^{d} − 1 DO

{

Send Zⱼ;
FOR ∈fₛ (i) DO (in increasing order)

Send Enc(SK1_k, Xⱼ);

}
FOR j = 0 ... b^{d} − DO
{

Send Exp(B, Yⱼ);
FOR k ∈ f_{S} (i) DO (in increasing order)

send Enc(SK_k, Yⱼ);

}

The algorithm is based on dividing the users into groups of size b^{2d}. A recursively encrypted copy of the multicast key is sent for each group individually, encrypted with Exp(Exp(B, Xⱼ), Yₖ) for all j, k corresponding to nonjoining users in the group and also encrypted with all group keys belonging to the group. The random bit sequences (address keys) Xⱼ, Yⱼ are send d times, each time encrypted with one of the selections keys SK1ₖ, SK2ₖ according to the digits of j in the number system to the basis b, respectively. The exponentials Exp(B, Yⱼ), Exp(B, Yⱼ) are sent without encryption.

A receiver with index n will be able to reconstruct MK out of the broadcasted stream if and only if joinₙ=1 by using the following algorithm:

| | |
|---|---|
| 1. | $h ← ⌊ \frac{n}{{b}^{2 d}} ⌋ ; s ← ⌊ \frac{n \% {b}^{2 d}}{{b}^{d}} ⌋ ; t ← n \% {b}^{d}$ |
| 2. | $Get {join}_{h \cdot {b}^{2 d}} , {join}_{h \cdot {b}^{2 d} + 1} , … {join}_{( h + 1 ) \cdot {b}^{2 d} - 1} ( ignore other bits sent ) ;$ |
| 3. | $FOR i = 0 … ⌊ \frac{N - 1}{{b}^{2 d}} ⌋ DO$ |

$Get H ; IF ( i = h ) THEN M ← H ;$

| | |
|---|---|
| 4. | FOR k ∈ f_{G} (h) DO (in decreasing order) |

$M ← Dec ( {GK}_{k} , M ) ;$

| 5. | FOR i = 1 ... 2 DO |
|---|---|
| | { |

$IF ( i = 1 ) THEN p ← s ; ELSE p ← t ;$
FOR j = ... b^{d} − 1 DO
{

Get Uᵢ^{j;}
${V}_{j}^{i} ← 0$
FOR k ∈ f_{S} (j) DO (in increasing order)
{

Get H;
$IF {V}_{j}^{i} = 0 ) AND ( k ∈ {f}_{\overline{S}} ( p ) ) {THENV}_{j}^{i} ← Dec ( Ski\_k , H ) ;$

}

}

| | } |
|---|---|
| 6. | FOR j = b^{d} − 1 ... 0 DO |

FOR k = b^{d}− 1 ... 0 DO

$IF ( {hb}^{2 d} + {jb}^{d} + k < N ) AND ( ! {join}_{{hb}^{2 d} + {jb}^{d} + k} ) THEN$
{

$IF ( j = s ) THEN H ← Exp ( {U}_{j}^{1} , {V}_{k}^{2} ) ; ELSE H ← Exp ( {U}_{j}^{2} , {V}_{k}^{1} ) ;$
$M ← Dec ( H , M ) ;$

}

| | |
|---|---|
| 7. | $MK ← M ;$ |

In step 2. and 3., the information relevant to the receiver group h is filtered out of the stream of data. Step 4. reverses the encryption with group keys. In step 5. the values Exp(B, Xⱼ), Exp(B, Yⱼ) are read and stored into two arrays Uⱼ² and Uⱼ¹,respectively. Also the bit sequences Xⱼ and Yⱼ are recovered by deciphering with the correct selection keys (if available). The results are stored into Vⱼ¹ and Vⱼ². Finally, in step 6. the bit sequences Exp(Exp(B, Xⱼ), Yₖ)=Exp(Exp(B, Yₖ), Xⱼ) are recovered for all non-joining users and used to decrypt the original multicast key.

FIG. 2b and 3b show the corresponding structure of the processing units 14 and 36 on the sender and receiver side. Since the structure largely corresponds to that of the first embodiment (FIG. 2a, 3a), only the differences of first and second embodiment will be further explained:

At the sender side, selection key storage 54 holds basic sets of two types of selection keys, first selection keys SK1_0, SK1_1, . . . and second selection keys SK2_0, SK2_1, . . . Also, address key generation unit 26 generates both first address keys X0, X1, . . . and second address keys Y0, Y1, . . .

Key encryption unit 28 encrypts first address keys X0, X1, . . . with first selection keys SK1_0, SK1_1, . . . as first encrypted address keys X0*, X1*, . . . and second address keys Y0, Y1, . . . with second selection keys SK2_0 SK2_1, . . . as second encrypted address keys Y0*, Y1*, . . . Key encryption unit 28 further calculates exponentials Z0, Z1 . . . as Exp (B, Y0), Exp (B, Y1), . . . as well as Exp(B, X₀), Exp(B, X₁), . . . and sends them without further encryption.

Multicast key encryption unit 24 uses group keys GK0, GK1, . . . from group key storage 52 and both first and second address keys X0, X1, . . . , Y0, Y1, . . . to generate encrypted multicast keys m1*, m2*, m3*, . . .

On the receiver side within processing unit 36 (FIG. 3b), key decryption unit 42 uses both first and second selection keys to decrypt encrypted address keys X0*, Y0*, . . .

Multicast key decryption unit 40 uses exponentials Z0, Z1, . . . , Exp (X0), . . . and both first and second address keys X0, Y0, . . . and Z0, Z1, . . . to decrypt encrypted multicast keys m1*, m2*, m3*, . . .

In the following an example of the second embodiment will be described in detail with regard to FIG. 14-23b.

In the example, the internal parameters are chosen as basis b=2, and dimension d=2. This leads two groups of size b^{2d}, i.e. each group comprises 16 receivers. For reasons of simplicity, only two groups will be regarded in this example. Again, a simple example with very few receivers has been chosen to demonstrate operation of the system.

The tables in FIG. 15a and 15b show the issuing scheme of selection keys for all 32 receivers of the example. Again, all members of the same group hold the same group keys. The distribution of selection keys among the receivers is the same for all groups.

Each group of b^{2d} members is divided into b^{d} subgroups of b^{d} members each. There are two types of selection keys, first selection keys SK1 to address the subgroup, and second selection keys SK2 to address an individual receiver position within a subgroup. Consequently, all receivers within the same subgroup have the same set of first address keys SK1 (for example, all members of subgroup 0 hold SK1_0 and SK1_1, and this applies to both groups 0 and 1). On the other hand, within each subgroup each receiver holds a unique set of second selection keys, but the distribution of second selection keys is the same for all four subgroups (for example the second receiver in each of the four subgroups holds SK2_0 and SK2_3, which again applies to all groups).

Again, the distribution of first and second selection keys is determined according to representation of a subgroup index (for first selection keys SK1) and a position index (for second selection keys SK2) in a number system to basis b. FIG. 14 gives the representation of digits in a dual number system for both first and second selection keys.

In step 2 of the sender algorithm given above, temporary address keys Xi, Yi are generated as random m-bit sequences (with m being the number of bits in the multicast key mk). Here Xi are used as first address keys, and Y_{J} are used as second address keys. Further, the base B is determined randomly as a random m-bit sequence.

Exponentials Z0, Z1, Z2, Z3 are calculated as Exp(B, Yi), and used as intermediate keys together with exponentials Exp (B, Xi). These values as shown in FIG. 17 are broadcast without encryption, and are therefore accessible for all receivers.

In the first part of step 4, each Xi is sent d times, each time encrypted with a different SK1, where the combination of first selection keys SK1 used for encryption is determined according to a representation of the subgroup index in a number system to basis b. Accordingly, in the second part of step 4, each second address key Yi is send d times, each time encrypted with a difference SK2, where the combination of second selection keys SK2 used is determined according to a representation of a position index in the number system to basis b.

In FIG. 18, the distribution of address keys among the receivers of group 0 resulting from the above distribution algorithm is given. It should be noted, that different from the first embodiment the algorithm includes temporarily storing the address keys at the receiver side.

As can be seen in FIG. 18, the distribution of first and second address keys among the receivers from group 0 is such that for each subgroup, there is one subgroup exclusion key out of the first address keys, which the members of that particular subgroup do not hold (for example, all members of subgroup 0 do not hold X0, while all other receivers do). Also, for each receiver within each subgroup there is one position exclusion key out of the second address keys, which the individual receiver does not hold, while all other members of the subgroup do (e.g. the first member of each subgroup, R0, R4, R8, R12 does not hold Y0, while all other receivers do).

In the following, encryption of the multicast key mk according to a joining vector 62 shown in FIG. 19 will be explained. In FIG. 20, the receivers comprised in group 0 are listed in a table, where all receivers in the same column have the same subgroup exclusion key, and all receivers in the same row have the same position exclusion key. For example, receiver R12 does not hold X3 and Y0, i.e. has subgroup exclusion key X3 and position exclusion key Y0.

From each of the exclusion key pairs (e.g. subgroup/position exclusion key) of the non-authorized receivers (R3, R6, R11, R12, R13 in the example), a mathematical combination is calculated as Exp(Zi, Yₖ) in step 3 of the sending algorithm. The multicast key mk is recursively encrypted using the combined keys thus generated. FIG. 21 shows the corresponding recursively encrypted multicast key mk as encrypted for group 0. This package is then further encrypted using all group keys of group 0 to give an encrypted packet mk*. A corresponding packet of this type is determined for each of the groups.

In the following, decryption of the encrypted multicast key mk* at an authorized receiver R5 (FIG. 23a) and a non-authorized receiver R11 (FIG. 23b) will be described. Receiver R5 holds group keys GK1, GK2 of group 0. R5 further holds all first address keys X, except for his subgroup exclusion key X1, and all second address keys Y, except for his position exclusion key Y1. R5 further holds, as all receivers, the above described exponentials (calculated result of exponentiation of base B with all first address keys X and second address keys Y).

Using this information, receiver R5 is able to calculate:
Exp(Z0, Y3) from Z0, Y3
Exp(Z1, Y2) from Z1, Y2
Exp(Z2, Y3) from Z2, Y3
Exp(Z3, Y0) from Z3, Y0

However, since R5 does not hold Y1, it is not able to calculate Exp(Z3, Y1) directly. But since R5 holds X3, it can nonetheless calculate Exp(Z3, Y1) as Exp(Exp(B, Y1), X3). Receiver R5 can thus decrypt mk*, because it can obtain all necessary keys. Receiver R5 is therefore able to obtain multicast key mk.

Turning now to FIG. 23b receiver R11 holds his group keys GK1, GK2 and all address keys except for his subgroup exclusion key X2 and position exclusion key Y3. R11 further holds all available exponentials.

Out of the keys used during generation of mk*, R11 is able to calculate
Exp(Z1, Y2) from Z1, Y2
Exp(Z3, Y1) from Z3, Y1
Exp(Z3, Y0) from Z3, Y0.

R11 is also able to calculate Exp(Z0, Y3) although it does not hold Y3. Since R11 holds X0, it can calculate Exp(Exp(B, Y3), X0).

However, R11 is not able to calculate Exp(Z2, Y3). On one hand, R11 does not hold its position exclusion key Y3. On the other hand, R11 does not hold its subgroup exclusion key X2. Consequently, there is no way for X11 to calculate Exp(Z2, Y3). R11 is therefor lacking one key to decrypt mk*, and consequently cannot obtain the multicast key mk.

There are a number of modifications possible to the above described embodiments.

A first modification eliminates in step 1 of the sending algorithm of both embodiments broadcasting of the complete joining vector. Instead, only changes to the joining vector are transmitted.

Another modification is directed to connections with a slow “last mile”, e.g. a computer network like the internet, where receivers are connected to access points by a relatively low bandwidth channel (e.g. modem). In this case, the access point could perform the filtering of step 2 and 3 and transmit only the b^{2d}+m bits relevant to the user over the slow last mile channel.

In the following, we look at the demands of the second embodiment with the regard to bandwidth, memory and number of computations, depending on the number of users n, key and block size m, and internal parameters g, b, d:

| | server side | user side |
|---|---|---|
| base keys | $2 bd + O ( {log}_{2} \frac{N}{{b}^{2 d}} )$ | 2(b − 1) d + g |
| broadcast bandwidth | $O ( N ( - α {log}_{2} α - ( 1 - α ) {log}_{2} ( 1 - α ) ) + m ( 2 ( d + 1 ) {b}^{d} + ⌈ \frac{N}{{b}^{2 d}} ⌉ )$ | |
| [bits] | | |
| work space [bits] | N + m(3b^{d} + 2) | b^{2d} + m (4b^{d}+ 1) |
| random bits | m (2b^{d} + 1) | 0 |
| exponentiations | 2b^{d} + αN | ≦ b^{2d}(αb^{2d} on the aver.) |
| en/decipherings [blocks] | $g \cdot ⌈ \frac{N}{{b}^{2 d}} ⌉ + 2 {db}^{d} + α N$ | ≦g + 2b^{d} + b^{2d}(g + 2b^{d} + αb^{2d}aver.) |

As in the first embodiment, also the second embodiment leaves some freedom with respect to adjusting the free parameters (b, d, g) according to the available resources.

The second embodiment may be used for scenarios with huge (millions to billions) numbers of potential users. In these situations, the number of base keys to be stored by the server is a critical factor (in addition to the required broadcast bandwidth).

Thus, we propose to optimize the total number of base keys under the constraint of an asymptotically “nice” behavior of broadcast bandwidth. The total number of group base keys G and the number of group base keys per user g must satisfy the following condition (since the

$$⌈ \frac{N}{{b}^{2 d}} ⌉$$

groups have to be identified by g-element subsets of the set of group base keys):

$$( \begin{matrix}G \\ g\end{matrix} ) \geq ⌈ \frac{N}{{b}^{2 d}} ⌉$$

Due to the symmetry of binomials, an almost optimal choice (in some cases the optimal solution is G=2g−1 but for the sake of simplicity, we neglect this case) is G=2g where g is the smallest natural number satisfying

$$( \begin{matrix}2 g \\ g\end{matrix} ) \geq \frac{N}{{b}^{2 d}} .$$

Using Stirling's approximation this leads to

$$G \geq {log}_{2} ( \frac{N}{{b}^{2 d}} ) - 2 + \frac{1}{2} {log}_{2} g \approx {log}_{2} N - 2 d \cdot {log}_{2} b$$

The total number of base keys is then approximately log₂N+2d(b−log₂b), so finding a suited working point with respect to base key number and required broadcast bandwidth leads to the following problem:

For a given N, “simultaneously minimize” 2d (b−log₂b) and

$$2 ( d + 1 ) {b}^{d} + ⌈ \frac{N}{{b}^{2 d}} ⌉ .$$

Obviously, there is no choice of (b, d) that minimizes both expressions at the same time, so there is a trade-off between broadcast bandwidth and base key number. For different values of N, reasonable choices for (b, d) may be found easily, but let us here try to give a general answer with the best possible asymptotical behavior (which may be a sub-optimal choice for some special N, however).

The asymptotically best broadcast bandwidth consumption is achieved if

$${b}^{d} \approx N \frac{1}{3} .$$

Substituting d by ⅓log_{b} N in the expression for the number of base keys, leads to the minimization problem

$${min}_{b ∈ N} \frac{b}{{log}_{2} b}$$

which is solved by b=3. Keeping b fixed, a minimal broadcast bandwidth corresponds to a solution of the equation b^{3d}(d+1+1/1nn)=N. For b=3, a good rule of thumb for finding the optimal d is given in the following formula:

$$d = ⌊ \frac{1}{3} ( {log}_{3} N - {log}_{3} ( \frac{1}{3} {log}_{3} N + 1 + \frac{1}{ln 3} ) + \frac{2}{ln 3} ) ⌋ \qquad ( 1 )$$

When inserting the resulting approximative values

$$\approx \frac{1}{3} {log}_{3} N , g \approx \frac{1}{6} {log}_{2} N + 2 , {b}^{d} \approx ( \frac{3 N}{{log}_{3} N} )$$

b=3, d in table 1 we obtain the following asymptotical behavior of the protocol:

| | server side | user side |
|---|---|---|
| base keys | $2 {log}_{3} N + \frac{1}{3} {log}_{2} N < 1.6 \cdot {log}_{2} N$ | ≈ log₂ N |
| broadcast bandwidth [bits] | $N \cdot ( - α {log}_{2} α - ( 1 - α ) {log}_{2} ( 1 - α ) ) + m \cdot {( 3 N )}^{\frac{1}{3}} {( {log}_{3} N )}^{\frac{2}{3}}$ | |
| work space [bits] | N | ${( 3 N / {log}_{3} N )}^{\frac{2}{3}}$ |
| random bits | $2 {m ( 3 N / {log}_{3} N )}^{\frac{2}{3}}$ | 0 |
| exponentiations | $2 {( 3 N / {log}_{3} N )}^{\frac{1}{3}} + α N$ | ${α ( 3 N / {log}_{3} N )}^{\frac{2}{3}}$ |
| en/decipherings [blocks] | $\approx \frac{1}{8} {{N}^{\frac{1}{3}} ( {log}_{3} N )}^{\frac{5}{3}} + α N$ | $2 {( 3 N / {log}_{3} N )}^{\frac{1}{3}} + {α ( 3 N / {log}_{3} N )}^{\frac{2}{3}}$ |

As an example, we consider the context of a pay-per-view service with N=2·10⁸ two hundred millions subscribers to a pay-per-view service.

In agreement to the rules given above the best choice for internal parameters is b=3, d=5, g=7. Let us assume that the key size of the multicast key and base keys is chosen m=256 bits. In the following table, the additional assumption α=0.95 has also been incorporated:

| | server side | user side |
|---|---|---|
| base keys | 44 | 27 |

| | |
|---|---|
| broadcast bandwidth | 7 MB |

| | | |
|---|---|---|
| work space | 24 MB | 38 kB |
| random bits | 125,000 | 0 |
| exponentiations | 10⁷ | max. 59,000 |
| en/decipherings [blocks] | 10⁷ | max. 60,000 |

As a further example, we consider multicast traffic in a computer network, e.g. the internet.

For a very large scenario, let us consider the number of potential users to be N=2³², i.e. the number of maximally available IP-addresses. The rules given above suggests b=3, d=6, g=8. The key size of the multicast key and base keys is set to m=256 bits and a is set to 0.999 (which means that 4.3 billion users are trying to buy the same content at the same multicast time slot). The requirement list then looks like this:

| | server side | user side |
|---|---|---|
| base keys | 52 | 32 |

| | |
|---|---|
| broadcast bandwidth | 6.4 MB (0.37 MB over last mile) |

| | | |
|---|---|---|
| work space | 512 MB | 156 kB |
| random bits | 370,000 | 0 |
| exponentiations | 4.3 · 10⁶ | aver. 530 |
| en/decipherings [blocks] | 4.4 · 10⁶ | aver. 2,000 |

In the last two rows, we give the average number of Diffie-Hellman exponentiation and block-ciphering steps, since the joining users can be assumed to be statistically well distributed over the groups. In the broadcast bandwidth entry, the potential benefit when using the above described modification, when the filtering of step 2 and 3 is performed at an access point in case of a slow last-mile channel is indicated.

As the above examples demonstrate, the proposed protocol allows multicast services for huge numbers of users with comparably low bandwidth consumption (even at high security levels, e.g. 256 bit keys) using a surprisingly low number of base keys.

In the above embodiments, it has been assumed that there is only one sender S, which broadcasts both scrambled content data and encrypted multicast key information. While it is preferred to transmit this information in the same broadcast stream of data, there may be other embodiments where key information on one hand and scrambled content data is actually sent separately, e.g. over different channels or by different sender entities.

While the above description shows examples of broadcasting systems and methods, these example were chosen merely for illustrated purposes and should not be construed as limiting the scope of a present invention. There a number of modification and extensions to the above systems and methods possible. For example, the range of users given for a medium sized or large scenario is a preferred choice, but the skilled person will appreciate that the algorithms may be used for different size scenarios.

1. System for selective multicast of a message,
with at least one sender (S), and key providing means (26, 52, 54) associated with said sender (S), for providing a base set of group keys (GK1, GK2, . . . ) and a base set of address keys (X0, X1, . . . Y0, Y1, . . . Z0, Z1, . . . ), and with sending means (16) for sending an encrypted message (mk*),
said system further comprising a plurality of receivers (R0, R1, . . . ) said receivers being members of a plurality of groups, and accessing means (42, 50) associated with each of said receivers for accessing individual receiver address key sets and one ore more group keys (GK),
where said one or more group keys (GK) are identical for all receivers of the same group,
where each of said receiver address key sets is a subset of said base set of address keys,
and said receiver address key sets are pairwise different for all pairs of receivers of the same group,
and where for each individual receiver, there is one or more exclusion key (X0, X1, . . . , Y0, Y1, . . . , Z0, Z1, . . . ) out of said base set of address keys, which is not contained in the receiver address key set of said receiver,
said system further comprising authorization storage means (30) to store authorization information about each of said receivers,
said system further comprising encryption means (24) for generating out of said message (mk) a plurality of encrypted messages (mk*),
where each of said encrypted messages (mk*) is encrypted with a combination of keys in such a way that it can only be decrypted using all keys out of the combination of keys,
where each of said encrypted messages (mk*) is aimed at a target group (G₀, G₁) out of said groups of receivers, and said combination of keys contains one or more group keys of said target group,
and where said combination further contains one or more exclusion key of non-authorized receivers of said target group.

2. System according to claim 1, where
a plurality of said receiver address key sets are identical for receivers of different groups.

3. System according to claim 1, where
said encryption means (24) are configured to recursively encrypt said message using said combination of keys.

4. System according to claim 1, said system further comprising
address key generating means (26) to generate said base set of address keys,
and selective key transmission means (28) for selectively transmitting said address keys to said receiver.

5. System according to claim 4, where
said key providing means (26, 52, 54) comprise storage means (54) at said sender configured to store a selection base set of cryptographic keys (SK0, SK1, . . . ),
and where each of said receivers comprises storage means (50) for storing a receiver selection key set,
where each of said receiver selection key sets is a subset of said selection base key set,
where said selection key sets of receivers of the same group are pairwise not contained in each other,
where a plurality of receiver selection key sets of receivers of different groups are identical,
and where said selective key transmission means (28) are configured to encrypt said address keys (X0, X1, . . . , Y0, Y1, Z0, Z1, . . . ) with one or more of said selection keys (SK1, SK2, . . . , SK1_0, SK1_1, . . . , SK2_0, SK2_1, . . . )

6. System according to claim 1, where
for each receiver (R), there is only one exclusion key contained in said base set of address keys, which is not contained in the receiver address key set of said receiver,
and where said exclusion key is contained in said receiver address key sets of the remaining receivers of the same group as said receiver.

7. System according to claim 5, where
each group contains maximally bd receivers, where b≧2 is an integer basis number and d≧1 is a dimension number,
and where said selection base key set contains b*d selection keys,
and where the receiver selection key set of each receiver contains (b−1)*d selection keys,
and where the receiver selection key set of each receiver corresponds to a representation of a receiver number r in a number system to basis b, with 0≦r≦b^{d}−1, where each digit of r is represented by one of d different selection keys.

8. System according to claim 7, where
said address base key set contains b^{d} address keys,
and where each of said address keys is transmitted d times, each times encrypted with a different one out of a transmitting combination of selection keys,
where said transmitting combination for each address key is chosen such that it corresponds to a representation of a key number t in a number system to basis b, with 0≦t≦b^{d}−1, where each digit of t is represented by one of d different selection keys.

9. System according to claim 1, where
for each receiver there are at least two exclusion keys out of said base set of address keys, which are not contained in the corresponding receiver address key set, and where each combination of exclusion keys is unique within each group.

10. System according to claim 1, where
said base set of address keys is divided into first address keys (SK1_0, SK1_1, . . . ) and second address keys (SK2_0, SK2_1, . . . ),
and where said groups (G₀, G₁) are divided into a plurality of subgroups,
where said receiver address key sets comprise a receiver set of first address keys and a receiver set of second address keys,
where the receiver address key set of each receiver within the same subgroup contains the same receiver set of first address keys,
and where the receiver address key set of each receiver contains a receiver set of second address keys unique within the subgroup of said receiver.

11. System according to claim 10, where
for each subgroup, there is one subgroup exclusion key out of said first address keys (X0, X1, . . . ) which is not contained in said receiver set of first address keys, where said subgroup exclusion key is contained in the receiver sets of first address keys of the receivers of the remaining subgroup of said group,
and where for each receiver, there is only one position exclusion key out of said second address keys (Y0, Y1, . . . ) which is not contained in said receiver set of second address keys, where said position exclusion key is contained in the receiver sets of second address keys of the remaining receivers of said subgroup,
and where said encryption means (24) are configured such that said exclusion keys are calculated from said subgroup exclusion keys and said position exclusion keys of said non-authorized receivers of said group.

12. System according to claim 11, where
said encryption means (24) are configured such that said exclusion keys are calculated by recursive exponentiation of said subgroup exclusion keys and said position exclusion keys.

13. System according to claim 10, where
each group contains maximally b^{2d} receivers, where b≧2 is an integer basis number and d≧1 is an integer dimension number, and each group contains maximally b^{d} subgroups with maximally b^{d} receivers in each subgroup,
and where said selection base key set contain 2*b*d selection keys, with b*d first selection keys (SK1_0, SK1_1, . . . ) and b*d second selection keys (SK2_0, SK2_1, . . . ),
and where the receiver selection key set of each receiver contains (b−1)*d first selection keys and (b−1)*d second selection keys,
and where the first selection key set in the receiver selection key set of each receiver corresponds to a representation of a receiver number r in a number system to basis b, with 0≦r≦b^{d}−1, where each digit of r is represented by one of d different selection keys,
and where the second selection key set in the receiver selection key set of each receiver corresponds to a representation of a subgroup number s in a number system to basis b, with 0≦s≦b^{d}−1, where each digit of s is represented by one of d different selection keys.

14. System according to claim 13, where
said address base key set contains b^{d} first address keys (X0, X1, . . . ) and b^{d} second address keys (Y0, Y1, . . . ),
and where each of said address keys is transmitted d times, each time encrypted with a different one out of a transmitting combination of selection keys,
where said transmitting combination for each address key is chosen such that it correspond to a representation of a key number t in a number system to basis b, with 0≦t≦b^{d}−1, where each digit of t is represented by one of d different selection keys.

15. Broadcasting system with
a sender (S) for broadcasting scrambled content messages (F1*, F2*, F3*, . . . ) said content messages being scrambled with at least one scrambling key (m1, m2, m3, . . . )
a plurality of receivers (R) for receiving said scrambled messages,
and a system (10) according to claim 1 for selectively transmitting said scrambling key (m1, m2, m3, . . . ) to authorized receivers.

16. Method for selective multicast of a message in a system including at least one sender (S) and a plurality of receivers (R), where said receivers are divided into a plurality of groups (G₀, G₁), comprising the steps of
providing a base set of group keys (GK),
providing a base set of address keys (Zⱼ, Xⱼ, Yⱼ),
providing for each of said receivers one or more group keys, where all of the receivers of the same group are provided with the same group keys,
providing a receiver address key set for each of said receivers,
where each of said receiver key sets is a subset of said base set of address keys,
and where for each receiver there is at least one exclusion key (Zⱼ, Xⱼ, Yⱼ) out of said base set of address keys, which is not contained in the corresponding receiver address key set,
obtaining information about unauthorized receivers and authorized receivers,
processing said message (mk) to generate a plurality of encrypted messages (mk*), each of said encrypted messages (mk*) being aimed at a target group of receivers,
where each of said encrypted messages (mk*) is encrypted using a combination of keys in such a way that it can only be decrypted using all keys out of said combination of keys,
and where said combination contains one or more group keys of the target group,
and where said combination contains a plurality of exclusion keys of non-authorized receivers of said target group,
and sending said encrypted messages from said sender to said receivers.

17. Method according to claim 16, where
said address key set is generated at said sender,
and said address keys out of said address key set are transmitted selectively to said receivers,
and said address key sets are used for transmitting a limited number of messages.

18. Method according to claim 16, where
said step of providing said receiver address key sets is effected after said step of sending said encrypted messages.

19. Method according to claim 18, where
said encrypted messages are decrypted at said receivers by using said receiver address keys upon reception, without storing a complete set of receiver address keys.
